(19) United States
(12) Patent Application Publication
(10) Pub. No.: US 2024/0092945 A1
(43) Pub. Date: Mar. 21, 2024

(54) SELF-SENSING AND SELF-HEALING OF STRUCTURAL POLYMERS AND COMPOSITES VIA INTEGRATION OF MICROVASCULATURE AND OPTICAL FIBERS

(71) Applicant: North Carolina State University, Raleigh, NC (US)

(72) Inventors: Jason PATRICK, Raleigh, NC (US); Zachary PHILLIPS, Raleigh, NC (US); Sherif Aboubakr, Raleigh, NC (US); William MARTIN, Raleigh, NC (US)

(21) Appl. No.: 18/467,968

(22) Filed: Sep. 15, 2023

Related U.S. Application Data
(60) Provisional application No. 63/375,861, filed on Sep. 16, 2022.

(51) Int. Cl. C08F 2/48; C08L 23/06; C08L 23/12; C08L 33/12; C08L 71/00; G02B 6/02; G02B 6/10

(52) U.S. Cl. CPC C08F 2/48; C08L 23/06; C08L 23/12; C08L 33/12; C08L 71/00; G02B 6/02; G02B 6/10; G02B 2006/12035

(57) ABSTRACT

In one aspect, the disclosure relates to self-healing systems including at least a structural polymer, a plurality of optical fibers or polymer waveguides embedded in the structural polymer, and a plurality of micro-channels through the structural polymer, wherein the micro-channels are configured to deliver a curing composition to at least one site of damage in the system. In another aspect, the curing composition can include a photo-polymerizable liquid monomer, and, optionally, a sensitizer, a photo-initiator, and/or a toughening agent, articles comprising the same, and methods of in situ self-healing of damage including Mode-I fractures using visible irradiation from the optical fibers or polymer waveguides to photo-polymerize the liquid monomer.

### CROSS-REFERENCE TO RELATED APPLICATIONS

This application claims the benefit of U.S. Provisional Application No. 63/375,861, filed on Sep. 16, 2022, which is incorporated herein by reference in its entirety.

### STATEMENT REGARDING FEDERALLY SPONSORED RESEARCH OR DEVELOPMENT

This invention was made with government support under grant number FA9550-18-1-0048 awarded by the United States Air Force Office of Scientific Research (USAF/AFOSR). The government has certain rights in the invention.

### BACKGROUND

Vascular systems are prevalent throughout the natural world to provide living organisms (i.e., plants and animals) with vital mass transport ability and achieve homeostatic functions including nutrient delivery for growth, coolant circulation for thermal regulation, and immune-response for injury repair (i.e., healing). Bioinspired implements of microvasculature in synthetic polymers and fiber-composites have enabled a plurality of functions (i.e., multi-functionality) that include self-healing, active-cooling, and even electro-magnetic modulation.

Self-sensing, of damage or temperature for instance, is a complementary and necessary biological function for survival. Neurological sensing is primarily based on electrical impulse transfer through a distributed neural network within a living organism. While many electrical-based sensing embodiments are prevalent in modern engineered materials, two-way coupling of self-sensing with self-healing is unrealized in the synthetic structural polymer domain, with only a few examples in soft material systems.

Fervent research efforts over the past twenty years have produced various synthetic polymers capable of self-repair. Self-healing functionality is engendered either by dynamic reassociation of chemical bonds within the base material (i.e., intrinsic), or the addition of an external healing agent to a host material (i.e., extrinsic). Intrinsic self-healing, while both innate and repeatable, is inherently reliant on covalent, electrostatic, or secondary molecular interactions at the angstrom-scale. Thus, intimate contact between fractured surfaces is required for damage recovery. Moreover, kinetic and thermodynamic thresholds for bond reassociation can hinder repair functionality. To wit, intrinsic healing is readily achieved in rubbery (non-structural) polymers—elastomers and gels—due to the relatively low energy thresholds for bonding. However, structural polymers—epoxies and vitrimers—often require significant energetic stimulus (e.g., heat) or tailored chemistries (e.g., Diels-Alder reactions) for damage restoration.

In contrast to intrinsic repair, extrinsic self-healing strategies afford distinct advantages in structural polymers. The inclusion and damage-induced rupture of microcapsules or hollow fibers filled with reactive liquid healing agents enables autonomic repair of internal cracks via in situ polymerization, thereby restoring mechanical function. However, repair capacity is limited by the volume of sequestered liquid and restricted to a single cycle in the proximity of fracture due to depletion of healing agent. Bioinspired microvascular self-healing distributes liquid chemistry throughout an interconnected network of micro-channels within the host material for repeatable repair via reactive healing agent replenishment and also filling larger damage volumes, for example mm-scale punctures via a two-stage chemistry. While repeat heal cycles have been demonstrated, this capability is curbed by the propensity for channel blockages due to healing agent cross-contamination. Additionally, in situ mixing of two-part healing chemistries is difficult without complex vasculatures or external pumping, and as such, the in situ polymerization of viscous agents is largely diffusion-dominated requiring timescales on the order of days.

One-part extrinsic liquid healing agents capable of polymerization via an external stimulus can circumvent liquid mixing, contamination, and timescale limitations. Pre-mixed epoxy agents or moisture sensitive cyanoacrylate have demonstrated autonomic, room-temperature (RT) healing capability, but with respective pot-life and reagent stability drawbacks. Solid to liquid phase-transitions via melting of extrinsic thermoplastic agents have recently enabled rapid (sub-hour) and prolonged (100 cycle) repair in structural composites, though in situ resistive heating requires wired electrical energy input (˜W) and a high glass-transition temperature (T_{g}≈150° C.) matrix to mitigate softening during healing. Induction heating of nanofillers within a thermoplastic healant can enable non-contact rapid, and repeatable repair, though much higher power (˜kW) is required compared to resistive heating and repair performance is attenuated by magnetic permeability and thermal diffusivity of the host material.

Apart from thermal repair methods, light-based self-healing has been achieved via fracture-induced release of liquid photo-chemistries from micro-capsules in coatings or from purposefully unpolymerized reservoirs in 3D printed structures by exposure to sunlight or artificial ultraviolet (UV) light), respectively. However, without light-guides to access internal damage in opaque structural materials (e.g., carbon-fiber composites), only superficial polymerization of photo-reactive agents is possible. Optical fiber waveguides—transparent fibers that achieve total internal reflection by having a core with higher refractive index that the encompassing cladding—feature low attenuation and as such dominant telecommunication infrastructure for energy-efficient and rapid data transmission. In some aspects, air fulfills this requirement for transparent polymers. In addition to being ideal candidates for internal polymerization needed for self-repair, optical fibers offer a practical self-sensing modality. However, optical fiber waveguides have yet to be explored in combination with other aspects of self-healing.

In living organisms, sensing and healing functionalities are autonomously coupled via a feed-back loop comprising three tenets8: (i) injury signals pain and initiates energy/nutrient transfer for healing; (ii) wound repair is continuously monitored and adjusted; and (iii) sensor function is concurrently restored to ensure repeatable performance upon re-injury, i.e., regeneration of a damaged nerve Synthetic materials exhibiting all three characteristics are sparse, and have only been demonstrated in soft material systems. Flexible supramolecular polymer composite “skins” containing metallic microparticles were able to sense mechanical forces via electrical resistance changes and also heal both mechanical/electrical functions after the material is cut and placed back into contact. In the field of soft-robotics, healing of severed elastomeric optical waveguides occurs via hydrogen and dynamic covalent bonding, whereas concurrent restoration of light-based sensing occurs over multiple damage-heal cycles.

However, in structural polymeric materials, independent, but not all combined sensing and healing principles have been realized. Successful damage detection by hollow cavity pressure monitoring in fiber-reinforced composites and embedded optical fiber probing in an epoxy thermoset have been deployed to autonomously trigger self-repair. Though healing of the sensor functions in either study was unrealized. In a separate work, an optical fiber strain sensor—manually cleaved and immersed in a vat of photo-chemistry—exhibited waveguide re-connection via in situ polymerization when UV light was transmitted through one end. However, the “self-writing” fiber did not duly repair mechanical properties of a solid host. Thus, achieving all three biological self-healing/sensing axioms in a single structural polymer has remained an unmet challenge.

Disclosed herein is a microvascular-based, self-healing structural system using a one-part, photo-reactive chemistry. The new platform employs internal micro-channels for fracture-induced, liquid healing agent transport to the damage zone in combination with embedded optical fibers or polymer waveguides for rapid (minute-scale), light-activated repair. In situ self-healing of mode-I fracture toughness via embedded POF performs at least as well as manual, ex situ recovery using an external light source. Moreover, the one-part cationic photochemistry formulated for visible light polymerization is 50× faster and achieves higher healing efficiencies than an established two-part, epoxy/amine system. The disclosed self-healing system can reduce or even eliminate routine inspection and manual repair of structural polymers/composites while enhancing in-service safety and reliability.

### SUMMARY

In accordance with the purpose(s) of the present disclosure, as embodied and broadly described herein, the disclosure, in one aspect, relates to self-healing systems including at least a structural polymer, a plurality of optical fibers or polymer waveguides embedded in the structural polymer, and a plurality of micro-channels through the structural polymer, wherein the micro-channels are configured to deliver a curing composition to at least one site of damage in the system. In another aspect, the curing composition can include a photo-polymerizable liquid monomer, and, optionally, a sensitizer, a photo-initiator, and/or a toughening agent, articles comprising the same, and methods of in situ self-healing of damage including Mode-I fractures using visible irradiation from the optical fibers or polymer waveguides to photo-polymerize the liquid monomer.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1C show opto-vascular self-sensing and self-healing concept. FIG. 1A: Internal fracture of optical fibers releasing light and sensing damage; FIG. 1B: Simultaneous rupture of micro-channels releasing one-part liquid photochemistry; FIG. 1C: Resulting photo-polymerization for in situ self-healing of host mechanical properties and restoration of optical fiber light transmission for repeated healing/sensing functionality.

FIGS. 2A-2L show photochemistry characterization, ex situ mechanical evaluation, and optical fiber integration. FIG. 2A: Molecular structures of photochemistry constituents. FIG. 2B: UV-Vis absorption spectra of different photochemistry formulations and emission profile of external light source (metal-halide bulb with 405 nm bandpass filter). FIG. 2C: Raman spectra at varying light doses (irradiance×time) highlighting reactive oxirane (1250 cm⁻¹) and invariant phenyl (1604 cm⁻¹) peaks. The plot inset depicts polymerization reaction progression versus time after exposure (i.e., dark cure) for various initial doses. FIG. 2D: Schematic of a modified tapered double cantilever beam (TDCB) mode-I fracture geometry containing internal micro-channels and a circular crack stop. The shaded rectangular region depicts the areal distribution of the external light source during ex situ healing. FIG. 2E: Autonomous delivery of liquid healing agent from fractured micro-channels: (I) immediately after unloading and (II) after full crack-length coverage.

FIG. 2F: (left y-axis) Photochemistry ex situ healing efficiency (η) versus light dose in comparison to a pre-mixed two-part (epoxy/amine) healing agent; (right y-axis) Photochemistry oxirane to phenyl Raman peak ratios versus light dose. FIG. 2G: Geometry and composition of polymer optical fibers (POFs); refractive index (n) of core/cladding in parenthesis. FIG. 2H: Thermo-mechanical behavior of pristine POF assessed via dynamic mechanical analysis (DMA). FIG. 2I: Laser-diode (405 nm) light transmission retention through POFs after 2 h exposure at various temperatures. FIG. 2J: Chemical etching of POF cladding after various times (scale bar=50 μm).

FIG. 2K: Fracture of etched POFs during TDCB testing (scale bar=1 mm). FIG. 2L: Zoomed insets: (left) POF fracture and (right) corresponding crack-plane illumination from a fiber-coupled laser-diode (405 nm) source with the overlaid intensity/irradiance (ϕ) distribution measured at the optical fiber centroid along the crack (scale bar=500 μm). Error bars represent the standard deviation from the mean (n=5).

FIGS. 3A-3I show in situ self-healing. FIG. 3A: Light exposure protocols for in situ healing experiments. FIG. 3B: Optical fiber illumination in translucent TDCB during single-fiber healing. Photochemistry sequestered within micro-channels fluorescing (≈480 nm; shown as darker gray) when excited by 405 nm light. FIG. 3C: In situ healing efficiency (η) summary for translucent samples relative to ex situ results and a pre-mixed two-part (epoxy/amine) healing agent. FIG. 3D: Healed fracture surfaces imaged via fluorescent microscopy; optical fibers are denoted by circles, with solid line perimeter signifying the fiber used for light delivery. FIG. 3E: Fiber illumination in an opaque TDCB during single-fiber healing where the epoxy matrix containing carbon-black (0.05 wt. %) absorbs light. FIG. 3F: In situ healing efficiency (η) summary for opaque samples relative to the translucent ex situ benchmark. FIG. 3G: Healed fracture surfaces imaged via fluorescent microscopy; dashed boxes designate location of optical fiber zoomed insets. FIG. 3H: Raman spectra of photochemistry after various levels of light exposure (i.e., doses) revealing polymerization progression. Notes: (i) individual spectra are normalized to respective phenyl peak (1610 cm⁻¹) intensity; (ii) shaded regions envelope the standard deviation from five scans. FIG. 3I: Average normalized Raman peak ratios obtained from the scans in (FIG. 3H). A cohesive failure corresponds to an under cured healing agent and an adhesive failure corresponds to a fully cured or nearly fully cured healing agent. Error bars represent the standard deviation from the mean (n=5).

FIGS. 4A-4D show self-sensing and autonomous self-healing. FIG. 4A: Images of light transmission through a polymer optical fiber (POF) and of neighboring micro-channels (with opaque coating) at various stages during a mode-I fracture/healing experiment in a TDCB. FIG. 4B: In situ light transmission measurements through the POF during a single fracture/healing cycle. A red (660 nm) fiber-coupled laser diode—outside the range of photochemistry absorption—interrogates crack activity (i.e., initial fracture, crack closure, fluid-filling) while a blue (405 nm) fiber-coupled laser diode initiates photopolymerization for mechanical recovery (e.g., self-healing). FIG. 4C: Representative POF light transmission profiles over multiple fracture/healing cycles. Measured intensity for the red (sensing) laser that falls below a threshold of 75% indicates fracture and automatically signals a microcontroller to power on the blue (healing) laser for a specified time. Shaded regions correspond to load/unload cycles in the test frame. FIG. 4D: Virgin and healed fracture toughness (KIC) summary along with calculated healing efficiencies (η) over three autonomous in situ self-healing cycles. Error bars represent the standard deviation from the mean (n=3).

FIGS. 5A-5B show candidate photochemistry screening. FIG. 5A: UV-Vis absorption of various healing agent formulations. FIG. 5B: Dynamic viscosity of candidate formulations calculated as the slope of shear rate v. shear stress.

FIG. 6 shows micro-channel sizing. Experimentally measured and theoretically predicted values of channel height.

FIG. 7 shows a geometry comparison: change in mode-I fracture toughness for each modification needed for targeted light and fluid delivery.

FIG. 8 shows representative fracture behavior of non-healing control with virgin and healed mode-I fracture of a sample with delivered healing agent but no light exposure.

FIGS. 9A-9E show optical fiber integration. FIG. 9A: Residual curing stress distribution of a neat TDCB and one containing silica fibers. FIG. 9B: Fracture behavior of silica-core fibers initially considered before polymer optical fibers (POFs). FIG. 9C: Thermo-mechanical aging of (I) a virgin POF fiber (II) when unconstrained (III) and constrained showing the formation and absence of defects, respectively. FIG. 9D: (I) Fiber bridging forming as a result of debonding at the fiber cladding-matrix interface, evident by index mismatch; (scale bar=5 mm) (II) Polished cross-section of a debonded fiber; (scale bar=100 μm)(III) SEM micrograph of a debonded fiber showing the separation between cladding and matrix. (scale bar=1 μm) FIG. 9E: Fracture of embedded optical fibers after etching and oven cure; SEM micrographs at (II) Fracture surface and (III) polished cross-section 10 mm away from fracture surface. A transparent overlay is provided for clarity.

FIGS. 10A-10B show degree of cure. FIG. 10A: Differential scanning calorimetry (DSC) of epoxy cured under the manufacturer recommended cure cycle. FIG. 10B: the modified cure cycle—necessary for POF survival—in comparison to a full exothermal cycle.

FIG. 11 shows a free-space irradiance measurement test setup as used herein.

FIG. 12 shows an overhead view of an optical test setup as used herein.

FIGS. 13A-13F show the mechanism of optical fiber photoinitiation. FIG. 13A: Proposed routes of light exposure within translucent and opaque TDCB samples. FIG. 13B: Optical transmittance of translucent and opaque epoxy. FIG. 13C: Fiber transmission experiments to isolate lateral polymerization. FIG. 13D: Fiber transmission experiments for combined lateral and longitudinal emission. FIG. 13E: Well experiment with opaque epoxy to isolate longitudinal transmission. FIG. 13F: Well experiments with translucent epoxy for combined lateral and longitudinal transmission.

FIGS. 14A-14C show tapered double cantilever beam (TDCB) calibration. FIG. 14A: Dynamic mechanical analysis (DMA) of the host thermoset under typical curing conditions. FIG. 14B: Comparison of dC/da across sample geometries. FIG. 14C: Adjusted a factors for converting peak load to mode-I fracture toughness across sample geometries.

FIG. 15 shows incremental healing: measured irradiance for four healing cycles with a 405 nm exposure.

FIG. 16A shows location of fiber markings to aid in fabrication procedure. FIG. 16B shows a graphical representation of the optional fiber etching procedure.

FIGS. 17A-17B show fabrication templates used herein. FIG. 17A: Template for aligning fluorocarbon monofilament with silicone mold halves for vascular channels. FIG. 17B: Optical fiber alignment template (units in mm).

FIG. 18 shows a modified tapered double cantilever beam (TDCB) geometry for in situ healing assessment, including optical fibers and micro-channels.

FIG. 19A shows images of in situ light delivery for single fiber (left) and overlaid sequential fibers (right) schemes. FIG. 19B shows a comparison of in situ and ex situ healing efficiencies, average healing efficiency values provided in the bottom of bar plots. Note: Error bars represent standard deviation from the mean (n=3).

FIG. 20 shows dark cure of one-part healing agent via protonic acid diffusion in absence of light over time after an initial exposure. Error bars represent standard deviation from the mean.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

In order to realize the essential integration of self-sensing and self-healing in synthetic structural polymers, a new light-based information/energy transfer pathway is disclosed herein, inspired by the naturally occurring optical fibers in a biological analogue: the glass sea sponge. In the disclosed system, optical fibers are combined with vascular conduits, architectures not necessarily found within a single organism in nature, but utilizing the inherent advantages of each evolutionary construct to realize a new ‘opto-vascular’ material system that couples self-sensing with self-healing for repeatable autonomous functionality in a structural thermoset.

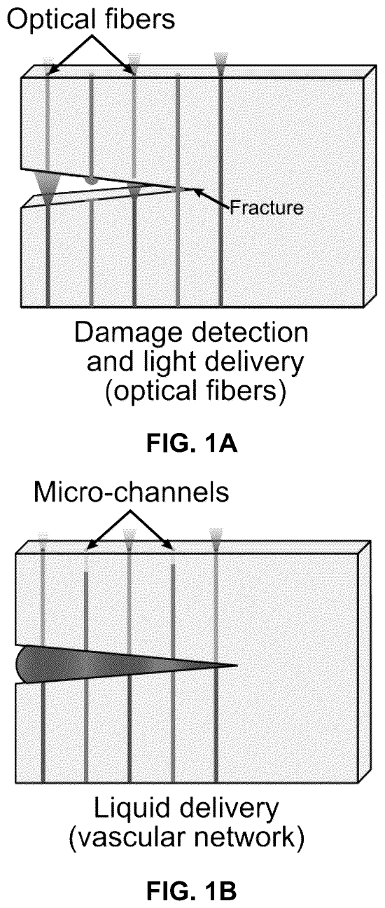

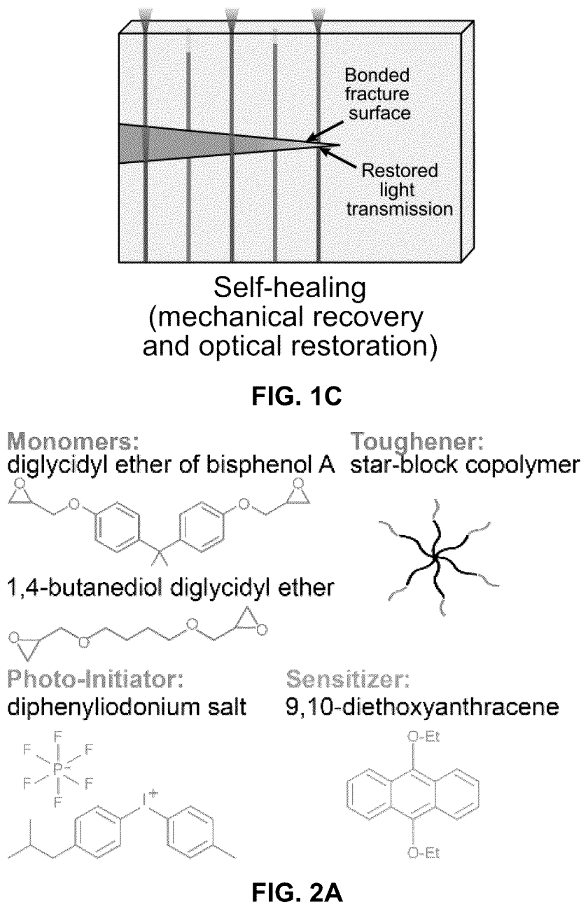

The disclosed system overcomes known limitations and couples self-healing and self-sensing within a structural polymer, thereby emulating functionalities inherent to advanced plant and animal life-forms. In one aspect, embedded optical fibers provide damage sensing and targeted light delivery for self-healing of internal fracture via in situ photo-polymerization of a one-part liquid chemistry released from ruptured microvasculature (FIGS. 1A-1C). In a further aspect, the fracture-induced loss in light transmission through the optical fibers signals damage. Further in this aspect, capillary pressure drives concurrent delivery of the healing agent from ruptured micro-channels filling the damage volume. In an alternative aspect, for larger volumes of healing agent, channel volume can be replenished by an external source by means of gravity feed or active pumping. In another aspect, the light diverted to the crack plane from severed optical fibers initiates photo-polymerization that rapidly re-bonds fracture surfaces, thereby restoring structural integrity. In any of these aspects, optical transmission is also restored due to index matching by the liquid and polymerized photochemistry enabling repeated self-sensing and autonomous self-healing.

Disclosed herein are systems and methods for microvascular delivery of liquid healing agents with targeted light delivery to repair internal damage such as, for example, fractures, via embedded optical fibers. In one aspect, an optical fiber network can be used in the disclosed systems and methods for self-sensing and repair of damage.

In an aspect, the disclosed systems and methods may be particularly useful in the aerospace and automotive industries, in naval applications, and for civil and energy infrastructure applications.

### Self-Healing System and Articles Including the Same

In one aspect, disclosed herein is a self-healing system including at least the following:
(a) a structural polymer;
(b) a plurality of optical fibers or polymer waveguides embedded in the structural polymer; and
(c) a plurality of micro-channels through the structural polymer,
wherein the micro-channels are configured to deliver a curing composition that includes a photo-polymerizable liquid monomer to at least one site of damage in the system.

In a further aspect, the structural polymer can include a thermoset polymer, a thermoplastic polymer, or a polymer-matrix composite. In a still further aspect, the thermoset polymer can be an epoxy, a polyurethane, a polyamide, or any combination thereof. In an alternative aspect, the thermoplastic polymer can be poly(methyl methacrylate) (PMMA), polyethylene (PE), polypropylene (PP), polyether ether ketone (PEEK), or any combination thereof.

In an aspect, the optical fibers are polymer optical fibers and include a core and a cladding. In one aspect, high-performance plastic optical fibers such as Eska™ from Mitsubishi Rayon Co., Ltd. (Tokyo, Japan) can be used for the polymer optical fibers. In a further aspect, in one non-limiting embodiment, the optical fiber can have a core material including a PMMA resin. In another non-limiting embodiment, the optical fiber can have a cladding material including a fluorinated polymer such as, for example, polytetrafluoroethylene (PTFE). In still another embodiment, the core can have a refractive index of about 1.49. In any of these aspects, the optical fiber can have a 0.5 numerical aperture. In one aspect, the optical fiber can have a core diameter of from about 217 μm to about 263 μm, or of about 240 μm. In a further aspect, the optical fiber can have a diameter including cladding of from about 227 μm to about 273 μm, or of about 250 μm; that is, the cladding can have a thickness of about 5 μm. In one aspect, the optical fiber can have an approximate weight of about 0.1 g/m. In some aspects, the cladding forms a continuous layer around the core. In an alternative aspect, one or more portions of the cladding can be removed via etching with a fluoropolymer, and the cladding forms a discontinuous layer around the core. In one aspect, the optical fiber can perform with no deterioration in optical properties at temperatures ranging from about −55° C. to about 70° C., or in 95% relative humidity to a maximum temperature of about 60° C. In a further aspect, the optical fiber exhibits a maximum transmission loss of about 300 dB/km using 650 nm collimated light under standard conditions with a 10 m−1 m cutback. In an aspect, the optical fiber has a minimum bend radius of about 5 mm and a tensile strength of about 3 N. In some aspects, the polymer waveguides achieve light transmission without a dedicated cladding.

In one aspect, the plurality of micro-channels form an interconnected network. In some aspects, one or more of the plurality of micro-channels can be an isolated channel. In any of these aspects, each one of the plurality of micro-channels has an average diameter of about 220 μm.

In one aspect, the photo-polymerizable liquid monomer can be diglycidyl ether of bispehnol A (DGEBA) and reactive viscosity reducer 1,4-butanediol diglycidyl ether. In another aspect, LED-curable adhesives such as Dymax MD® from Dymax Corporation (Torrington, CT) can be used in embodiments of the present disclosure such as, for example, as the photo-polymerizable liquid monomer. In a further aspect, the adhesive may have a color prior to curing, but can transition to colorless when sufficient energy has been delivered to achieve full cure. In some aspects, the adhesive may fluoresce bright red under low-intensity black light. In one aspect, the adhesive may be solvent free and may be or include an acrylated urethane. Prior to cure, the adhesive can be a blue translucent liquid with a density of about 1.01 g/mL and a viscosity of about 450 cP. Once cured, in an aspect, the adhesive can have a hardness of about 53 Shore D, a tensile at break of about 11.0 mPa, an elongation at break of about 300%, and an elastic modulus of about 105.4. In a further aspect, the cured adhesive can have a refractive index at 20° C. of about 1.50, a linear shrinkage of about 2.2%, and a glass transition temperature (T_{g}) of about 77° C. In another aspect, the cured adhesive can have a coefficient of thermal expansion α₁ of about 141 μm/m/° C. and a coefficient of thermal expansion α₂ of about 225 μm/m/° C. In some aspects, curing time can be affected by both adhesive thickness and wavelength of light used to activate curing. In an aspect, when 200 nm light (10 W/cm²) is used, curing can be accomplished in about 1.4 s for a 0.10 mm thickness and about 1.0 s for an 0.81 mm thickness. In another aspect, when a 365 nm light (15 W/cm²) is used, curing time is about 1 s for any thickness between about 0.10 mm and 0.81 mm. In a further aspect, when a 385 nm light (15 W/cm²) is used, curing time is about 3.5 s for a 0.10 mm adhesive layer while a 0.81 mm adhesive layer cures in about 1.5 s. In still another aspect, when a 405 nm light (15 W/cm²) is used, a 0.10 mm layer of adhesive takes about 36.5 s to cure while a 0.81 mm adhesive layer takes about 12.0 s to cure.

In some aspects, the curing composition further includes a sensitizer. In a further aspect, the sensitizer can absorb visible light between at least 325 nm and 425 nm, or at about 325, 330, 335, 340, 345, 350, 355, 360, 365, 370, 375, 380, 385, 390, 395, 400, 405, 410, 415, 420, or about 425 nm, or a combination of any of the foregoing values, or a range encompassing any of the foregoing values. In some aspects, the curing composition includes from about 0.1 wt % to about 2 wt % of the sensitizer, or about 0.1, 0.25, 0.5, 0.75, 1, 1.25, 1.5, 1.75, or about 2 wt % of the sensitizer. In an aspect, Anthracure™ UVS-1101 from Kawasaki Kasei Chemicals, Ltd. (Kawasaki City, Japan) can be used as the photosensitizer. In some aspects, the photosensitizer can be anthracene or an anthracene derivative such as, for example, 9,10-diethoxyanthracene.

In an aspect, the curing composition can further include a photo initiator, a free-radical initiator, or any combination thereof. In one aspect, the curing composition includes from about 2 wt % to about 8 wt % of the photo initiator, or about 2, 3, 4, 5, 6, 7, or about 8 wt % of the photo initiator, or a combination of any of the foregoing values, or a range encompassing any of the foregoing values. In some aspects, the photo-initiator can be a diphenyliodonium salt. In another aspect, Irgacure® from BASF Corporation (Florham Park, NJ) can be used as the photo initiator. In some aspects, the photo initiator can include from about 25 to about 50% (w/w) of propylene carbonate and/or from about 75% to about 100% of (4-Isobutylphenyl)(p-tolyl)iodonium hexafluorophosphate (also known as 4-methyl-4′-isobutyl-diphenyliodonium hexafluorophosphate). In a further aspect, the photo initiator has a density of about 1.46 g/cm³.

In some aspects, the curing composition further includes a toughening agent. In a further aspect, the toughening agent can be a polyol-based and/or phase-separated star block copolymer. In still another aspect, a product such as, for example, Fortegra™ 100 from Dow Chemical Company (Midland, MI) can be used as a toughening agent. In one aspect, the toughening agent can be a phase-separated star block copolymer. In some aspects, the toughening agent can provide improved toughness without significantly affecting viscosity, glass transition temperature, corrosion resistance, cure rate, or chemical resistance of the material to be toughened. In some aspects, the toughening agent, when added to a thermoset formulation, is added only to the epoxy side. In any aspect, the toughening agent can be post-added to the epoxy side as long as it is completely mixed into the epoxy prior to the addition of a curing agent. In some aspects, the toughening agent can be added in an amount of about 3% to about 8% by dry volume. In an aspect, the toughening agent has a viscosity of about 4500 mPa·s at 20° C., about 3600 mPa·s at 25° C., and about 2000 mPa·s at 35° C. In a further aspect, the toughening agent has a density of about 1.03 g\mL and is 100% non-volatile.

In one aspect, the self-healing system can be translucent. Further in this aspect, the optical fibers or polymer waveguides can be spaced about 5 mm apart. In another aspect, the self-healing system can be opaque, and the optical fibers or polymer waveguides can be spaced about 2 mm apart.

In any of these aspects, the damage can be Mode-I fracture. Further in this aspect, the damage can fracture at least one of the plurality of micro-channels and, optionally, at least one of the plurality of optical fibers or polymer waveguides. In a further aspect, fracture of the at least one of the plurality of micro-channels releases the curing composition around a site of the damage.

Also disclosed herein are articles including the disclosed self-healing system such as, for example, aerospace components, aviation components, naval components, infrastructure components, or any combination thereof.

### Method for In Situ Self-Healing

In one aspect, disclosed herein is a method for in situ self-healing of at least one site of damage in a disclosed system or article, the method including irradiating the at least one site of damage using UV and/or visible light from one or more of the plurality of optical fibers or polymer waveguides. In some aspects, use of UV light may cause UV-induced damage. In other aspects, natural sunlight and/or a UV halide bulb may be used in the disclosed method and system without causing damage. In a further aspect, irradiating can be carried out for from about 5 minutes to about 135 minutes, or for about 5, 10, 15, 20, 25, 30, 35, 40, 45, 50, 55, 60, 65, 70, 75, 80, 85, 90, 95, 100, 105, 110, 115, 120, 125, 130, or about 135 minutes, or a combination of any of the foregoing values, or a range encompassing any of the foregoing values.

In another aspect, the method further includes an additional dark curing step following the irradiating. Further in this aspect, the dark curing step can be carried out for from about 1 hour to about 6 hours, or for about 1, 1.5, 2, 2.5, 3, 3.5, 4, 4.5, 5, 5.5, or about 6 hours, or a combination of any of the foregoing values, or a range encompassing any of the foregoing values.

In one aspect, irradiation can be accomplished using a single one of the plurality of optical fibers or polymer waveguides, or can be accomplished sequentially by at least three of the plurality of optical fibers or polymer waveguides. In another aspect, irradiating can be carried out at from about 400 to about 410 nm, or at about 405 nm. In another aspect, irradiating delivers a dose of energy of from about 0.75 to about 5400 J/cm² to the at least one site of damage, or of about 0.75, 1, 5, 10, 25, 50, 75, 100, 250, 500, 750, 1000, 1500, 2000, 2500, 3000, 3500, 4000, 4500, 5000, or about 5400 mJ/cm². In an aspect, energy intensity measurements are taken perpendicular to the crack plane using a spectrometer at the epoxy surface of a tapered double cantilever beam (TDCB).

In any of these aspects, the method further includes detecting the at least one site of damage prior to irradiating. In a further aspect, detecting the at least one site of damage can be accomplished by identifying an intensity drop in through-transmission of visible light in at least one of the plurality of optical fibers or polymer waveguides. In another aspect, the self-healing system experiences at least 65% structural recovery after performing the method, or at least 70, 75, 80, 85, 90, 95, 99, 100, 110, 120, 130, 140, 150, 160, 170, or 180% structural recovery after performing the method. In a still further aspect, the self-healing system experiences recovery of intensity of through-transmission of visible light in at least one of the plurality of optical fibers or polymer waveguides after performing the method. In an aspect, visible light wavelength for measuring through-transmission and assessment of damage and recovery can be of any wavelength. However, in a further aspect, red light may be particularly useful as it will not activate the photochemistry disclosed herein. In another aspect, and without wishing to be bound by theory, healing agent infiltration of the damage volume can restore optical transmission due to indexing matching across fractured fiber surfaces. In a further aspect, light exposure solidifies this material in place, providing additional mechanical recovery.

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by,” “comprising,” “comprises,” “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a photoinitiator,” “a sensitizer,” or “a structural polymer,” include, but are not limited to, mixtures or combinations of two or more such photoinitiators, sensitizers, or structural polymers, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y.’ The range can also be expressed as an upper limit, e.g. ‘about x, y, z, or less’ and should be interpreted to include the specific ranges of ‘about x,’ ‘about y’, and ‘about z’ as well as the ranges of ‘less than x’, less than y′, and ‘less than z’. Likewise, the phrase ‘about x, y, z, or greater’ should be interpreted to include the specific ranges of ‘about x,’ ‘about y,’ and ‘about z’ as well as the ranges of ‘greater than x,’ greater than y,′ and ‘greater than z.’ In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of irradiation refers to an amount that is sufficient to achieve the desired improvement in the property modulated by the formulation component, e.g. achieving the desired level of curing or cure time. The specific level in terms of radiation dose required as an effective amount will depend upon a variety of factors including the number of optical fibers or polymer waveguides from which irradiation occurs, opacity or lack thereof of the self-healing system, extent of damage, spacing of optical fibers, and end use of the article incorporating the self-healing system.

As used herein, the terms “optional” or “optionally” means that the subsequently described event or circumstance can or cannot occur, and that the description includes instances where said event or circumstance occurs and instances where it does not.

In one aspect, the self-healing systems disclosed herein include a “thermosetting polymer.” In another aspect, a thermosetting polymer or resin is irreversibly hardened upon curing, which can be induced by heat or radiation, as appropriate for the polymer. In one aspect, curing involves the formation of irreversible chemical bonds. Curing can be further promoted by the application of pressure, mixing with a catalyst, or reaction with a curing agent. In one aspect, it is typically possible to manipulate a thermosetting polymer prior to curing, e.g., by molding or pouring, but following curing, a thermosetting polymer cannot be melted and reshaped.

In another aspect, the self-healing systems disclosed herein include a “thermoplastic material.” As used herein, a thermoplastic material is typically a polymer with a high molecular weight that, at elevated temperature, regains a degree of pliability or moldability. In one aspect, upon cooling, a thermoplastic material re-solidifies.

As used herein, an “amorphous” thermoplastic material lacks a crystalline structure and may be susceptible to chemical degradation or environmental stress cracking, but are easy to thermoform and tend to have good impact resistance. Amorphous thermoplastics tend to have a broad softening range, as well. Meanwhile, a “semi-crystalline” thermoplastic does not fully crystallize below its glass transition temperature, may be difficult to thermoform, and has only average impact resistance. However, in one aspect, semi-crystalline thermoplastics tend to be resistant to chemicals and suitable for structural applications and to have a sharp melting transition.

“Self-healing” as used herein refers to the process by which a material that has been damaged returns to an undamaged state. In one aspect, self-healing materials exhibit the ability to repair themselves using the resources inherently available to them. In some aspects, the repair process can be autonomic while in other aspects, the repair process can be externally assisted (e.g., by applied heating). In any of these aspects, the recovery process is triggered by damage to the material. In one aspect, the systems disclosed herein can be self-healing without the need for external assistance. In one aspect, following self-healing, the systems return to a state in which the material's properties are comparable to the properties of the material prior to the occurrence of any damage. In another aspect, following self-healing, the sites of crack or fracture initiation are repaired, as are existing cracks and fractures. In a further aspect, following self-healing, the material can safely be used for its original intended purpose without increased likelihood of failure; for example, an aircraft having a body panel made from or including a self-healing system as disclosed herein, wherein the system had undergone a self-healing cycle following damage, would be suitable for flight without additional repairs.

When self-healing occurs “in situ,” the self-healing process can be accomplished without removing the system from or disassembling components of the structure in which it is installed (e.g., aircraft, watercraft, infrastructure components, and the like).

The “double cantilever beam fracture test” (also referred to as “DCB test”) is a method for characterizing mode-I fracture resistance of composite materials. In some aspects, a composite material is initially partly debonded with a debond length and subjected to symmetrical transverse forces. Delamination is propagated until a set crack length is reached (which is, in some aspects, about 60 mm), at which time the forces are removed. Mode-I critical fracture energy (GIC), or strain energy release rate, can then be calculated.

The “tapered double cantilever beam fracture test” (also referred to as “TDCB test”) is another method for characterizing mode-I fracture resistance of composite materials. TDCB and DCB specimens use the same principles in performance of the tests but TDCB test specimens use a different sample geometry that reduces stress concentration at the start of a crack, ensuring stability during the fracture process and making the test sample amenable to the collection of measurements. In some aspects, TDCB tests may therefore have more accurate results than DCB tests.

A “mode-I fracture” is an “opening” or separation between two layers of a laminate material, or a tensile stress normal to the plane of the layers. “Mode-I fracture resistance” refers to the ability of a composite laminate material to resist this type of damage. In one aspect, the self-healing systems disclosed herein exhibit good mode-I fracture resistance even after repeated cycles of self-healing.

Unless otherwise specified, pressures referred to herein are based on atmospheric pressure (i.e. one atmosphere).

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### Aspects

The present disclosure can be described in accordance with the following numbered Aspects, which should not be confused with the claims.

Aspect 1. A self-healing system comprising:
(a) a structural polymer;
(b) a plurality of optical fibers or polymer waveguides embedded in the structural polymer; and
(c) a plurality of micro-channels through the structural polymer,
wherein the micro-channels are configured to deliver a curing composition comprising a photo-polymerizable liquid monomer to at least one site of damage in the system.

Aspect 2. The self-healing system of aspect 1, wherein the structural polymer comprises a thermoset polymer, a thermoplastic polymer, or a polymer-matrix composite.

Aspect 3. The self-healing system of aspect 2, wherein the thermoset polymer comprises an epoxy, a polyurethane, a polyamide, or any combination thereof.

Aspect 4. The self-healing system of aspect 2, wherein the thermoplastic polymer comprises poly(methyl methacrylate) (PMMA), polyethylene (PE), polypropylene (PP), polyether ether ketone (PEEK), or any combination thereof.

Aspect 5. The self-healing system of any one of aspects 1-4, wherein the optical fibers comprise polymer optical fibers, and wherein the polymer optical fibers comprise a core and a cladding.

Aspect 6. The self-healing system of aspect 5, wherein the core comprises poly(methyl methacrylate) (PMMA).

Aspect 7. The self-healing system of aspect 5 or 6, wherein the core has an average diameter of about 240 μm.

Aspect 8. The self-healing system of any one of aspects 5-7, wherein the cladding comprises polytetrafluoroethylene (PTFE).

Aspect 9. The self-healing system of any one of aspects 5-8, wherein the cladding has a thickness of about 5 μm.

Aspect 10. The self-healing system of any one of aspects 5-9, wherein the cladding forms a continuous layer around the core.

Aspect 11. The self-healing system of any one of aspects 1-4, wherein the polymer waveguides achieve light transmission without a dedicated cladding.

Aspect 12. The self-healing system of any one of aspects 1-11, wherein the plurality of micro-channels form an interconnected network.

Aspect 13. The self-healing system of any one of aspects 1-11, wherein one or more of the plurality of micro-channels comprises an isolated channel.

Aspect 14. The self-healing system of any one of aspects 1-13, wherein each one of the plurality of micro channels has an average diameter of about 220 μm.

Aspect 15. The self-healing system of any one of aspects 1-14, wherein the photo-polymerizable liquid monomer comprises diglycidyl ether of bispehnol A (DGEBA) and reactive viscosity reducer 1,4-butanediol diglycidyl ether.

Aspect 16. The self-healing system of any one of aspects 1-15, wherein the curing composition further comprises a sensitizer.

Aspect 17. The self-healing system of aspect 16, wherein the sensitizer absorbs visible light between at least 325 nm and 425 nm.

Aspect 18. The self-healing system of aspect 16 or 17, wherein the curing composition comprises from about 0.1 wt % to about 2 wt % of the sensitizer.

Aspect 19. The self-healing system of aspect 18, wherein the curing composition comprises about 2 wt % of the sensitizer.

Aspect 20. The self-healing system of any one of aspects 16-19, wherein the sensitizer comprises anthracene or an anthracene derivative.

Aspect 21. The self-healing system of aspect 20, wherein the anthracene derivative comprises 9,10-diethoxyanthracene.

Aspect 22. The self-healing system of any one of aspects 1-21, wherein the curing composition further comprises a photo-initiator, a free-radical initiator, or any combination thereof.

Aspect 23. The self-healing system of aspect 22, wherein the curing composition comprises from about 2 wt % to about 8 wt % of the photo-initiator.

Aspect 24. The self-healing system of aspect 23, wherein the curing composition comprises about 4 wt % of the photo-initiator.

Aspect 25. The self-healing system of any one of aspects 22-24, wherein the photo initiator comprises a diphenyliodonium salt.

Aspect 26. The self-healing system of aspect 25, wherein the diphenyliodonium salt comprises 4-methyl-4′-isobutyl-diphenyliodonium hexafluorophosphate.

Aspect 27. The self-healing system of any one of aspects 1-26, wherein the curing composition further comprises a toughening agent.

Aspect 28. The self-healing system of aspect 27, wherein the toughening agent comprises a phase-separated star block copolymer.

Aspect 29. The self-healing system of any one of aspects 1-28, wherein the self-healing system is translucent.

Aspect 30. The self-healing system of aspect 29, wherein the optical fibers or polymer waveguides are spaced about 5 mm apart.

Aspect 31. The self-healing system of any one of aspects 1-28, wherein the self-healing system is opaque.

Aspect 32. The self-healing system of aspect 31, wherein the optical fibers or polymer waveguides are spaced about 2 mm apart.

Aspect 33. The self-healing system of any one of aspects 1-32, wherein the damage comprises Mode-I fracture.

Aspect 34. The self-healing system of any one of aspects 1-33, wherein the damage fractures at least one of the plurality of micro-channels and, optionally, at least one of the plurality of optical fibers or optical waveguides.

Aspect 35. The self-healing system of aspect 34, wherein fracture of the at least one of the plurality of micro-channels releases the curing composition around a site of the damage.

Aspect 36. An article comprising the self-healing system of any one of aspects 1-35.

Aspect 37. The article of aspect 36, wherein the article comprises an aerospace component, an aviation component, a naval component, an infrastructure component, or any combination thereof.

Aspect 38. A method for in situ self-healing of at least one site of damage in the system of any one of aspects 1-35 or the article of aspect 36 or 37, the method comprising irradiating the at least one site of damage using visible light from one or more of the plurality of optical fibers or polymer waveguides.

Aspect 39. The method of aspect 38, wherein irradiating is carried out for from about 5 minutes to about 135 minutes.

Aspect 40. The method of aspect 38 or 39, further comprising an additional dark curing step following the irradiating.

Aspect 41. The method of aspect 40, wherein the dark curing step is carried out for from about 1 hour to about 6 hours.

Aspect 42. The method of any one of aspects 38-41, wherein irradiation is accomplished using a single one of the plurality of optical fibers or polymer waveguides.

Aspect 43. The method of any one of aspects 38-41, wherein irradiation is accomplished sequentially by at least three of the plurality of optical fibers or polymer waveguides.

Aspect 44. The method of any one of aspects 38-43, wherein irradiating is carried out at from about 400 to about 410 nm.

Aspect 45. The method of aspect 44, wherein irradiating is carried out at 405 nm.

Aspect 46. The method of any one of aspects 38-45, wherein irradiating delivers a dose of energy from about 0.75 to about 5400 J/cm² to the at least one site of damage.

Aspect 47. The method of any one of aspects 38-46, further comprising detecting the at least one site of damage prior to irradiating.

Aspect 48. The method of aspect 47, wherein detecting the at least one site of damage is accomplished by identifying an intensity drop in through-transmission of visible light in at least one of the plurality of optical fibers or polymer waveguides.

Aspect 49. The method of any one of aspects 38-48, wherein the self-healing system experiences at least 65% structural recovery after performing the method.

Aspect 50. The method of any one of aspects 38-48, wherein the self-healing system experiences at least 90% structural recovery after performing the method.

Aspect 51. The method of any one of aspects 38-50, wherein the self-healing system experiences recovery of intensity of through-transmission of visible light in at least one of the plurality of optical fibers or polymer waveguides after performing the method.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: Materials and Methods

### Materials

Fracture specimens are fabricated from an aerospace-grade epoxy resin/amine hardener system (Araldite 8605/Aradur 8605H, Huntsman Advanced Materials, LLC). Bare polymer optical fibers (POFs) are purchased (Super Eska SK-10, Mitsubishi Chemical, Corp.) with a core/cladding diameter of 240/250 μm. Fiber etching is performed with a sodium naphthalide based etchant (FluoroEtch, Action Technologies, Inc). Protection sleeves for fibers are made using polytetrafluoroethylene (PTFE) tubing with an ID/OD of 0.30 mm/0.76 mm (Cole Parmer Instrument Company, Inc). The healing agent is composed of base monomer (EPNC-1, Spectra), photoinitiator (Omnicat 250, IGM Resins), and photosensitizer (Anthracure UVS1101, Kawasaki Kasei Chemicals) which are combined as purchased.

### Photochemistry Healing Agent Formulation

Photoactive components are amalgamated within a 20 mL glass vial wrapped in several layers of vinyl electrical tape (Super 88, 3M, Inc.) to prevent premature light exposure. An analytical scale (XS204, Mettler Toledo) is used to weigh each component and achieve the following relative concentrations: 94 wt % monomer, 4 wt % photoinitiator, and 2 wt % photosensitizer. Components are mixed using a vortex mixer (LP Vortex Mixer, Thermo Scientific) at 3000 rpm for 45 minutes. The resulting chemistry is degassed at room temperature (RT) and atmospheric pressure for 24 hours.

### Fiber Etching

Optical fibers are cut to lengths of 60 cm and delineated with two sets of markings: one pair at 25/35 cm to align with the fracture specimen mold, and a second pair at 29.5/30.5 cm to define a 10 cm region for etching. The marked 10 cm length of fiber is etched by immersion in FluoroEtch for 2 seconds. Etchant is then neutralized with sequential 5 second rinses in 2-propanol (A451-4, Fisher Chemical, Inc.), water, and water plus 5% acetic acid. Residual moisture is gently removed with a lint-free tissue (Kimwipe, Kimberly-Clark), and fibers are allowed to air dry for 1 hour before fracture sample fabrication.

### Tapered Double Cantilever Beam (TDCB) Manufacture

Plain tapered double cantilever beam (TDCB) specimens are cast within two mating silicone molds (RTV 630, Momentive) placed between aluminum plates and secured with spring clamps. For TDCB specimens with embedded microchannels, fluorocarbon monofilaments (VSP6-15, Berkley) are cut to approximately 20 cm, pulled taught, and secured over one mold half prior to casting, while preserving alignment with a custom fixture. Vacuum grease (Molykote, Dupont, Inc.) is applied over the fiber/mold contact interfaces to prevent epoxy leakage. TDCB samples containing both internal micro-channels and embedded optical fibers require a different custom fixture to align the optical fibers while maintaining the fiber tension necessary to overcome thermally induced shrinkage. High-temperature silicone separates the garolite arms from the supporting aluminum bar. After monofilaments are secured to one mold half, etched optical fibers are also laid across the silicone mold. Two PTFE sleeves (0.254 mm ID, 35 mm length) for each fiber are placed at the top and bottom edge of the TDCB cavity to prevent fiber damage during sample de-molding. Lead weights (25 g) are attached to one end of the fiber while the free end is secured with a c-clamp. An additional c-clamp is used to fix the second end and maintain the tension in the fiber. Fibers are protected from crushing by placing 25 mm square of high temperature silicone and glass-fiber composite between the fiber and the c-clamp.

For each TDCB sample configuration, liquid epoxy resin/amine hardener (Araldite/Aradur 8605, 100:35 by wt.) is mixed and degassed for 40 min at 2 Torr (abs.). After samples precure for 24 h at RT, they undergo an oven cycle at 100° C. for 24 hours. The samples are then demolded and a 3.97 mm hole is drilled at the end of the taper region as a crack-stop to prevent a fractured sample from completely separating. An initial pre-crack is formed by carefully tapping a razor blade into the molded starter notch.

### Fracture Testing and Self-Healing

Mode-I fracture testing of TDCB specimens is conducted using a 5 kN electro-mechanical load frame (Alliance RT/5, MTS Inc.) with a 250 N load cell. Specimens are loaded at a rate of 5 s⁻¹ through multiple crack propagation events until the crack reaches the crack stop. The TDCB arms are held at the final displacement for 5 min to promote fluid delivery before unloading to zero-displacement at the same 5 μm s⁻¹ rate. After unloading, the specimen remains in the load-frame undisturbed during continued fluid delivery.

In situ self-healing via photopolymerization is performed at zero crosshead displacement within the load frame. A fiber-coupled laser diode with a single-mode fiber (QFLD-405-20S) provides the light required for photoinitiation. The diode is powered and thermally managed by a combined laser+TEC controller (ComboSource 6301, Arroyo Instruments, LLC) according to manufacturer specifications. Connections to embedded optical fibers are enabled by bare fiber connectors (BFT1, ThorLabs, Inc) with ceramic FC/PC ferrules (B30270C, ThorLabs, Inc). Specimens are exposed by light applied through optical fibers for the specified amount of active exposure (t_{active}) and then are immediately retested to assess healing efficiency.

For all testing conditions, mode-I fracture toughness (KIC) is calculated by the relation:

K_{IC}=αP_{c}

where α is an experimentally derived constant (0.0112) and P_{c} is the average peak load obtained during testing from the multiple fracture events.

Healing efficiency is calculated as the ratio between the healed and virgin mode-I fracture toughness according to the established relation:

$$η = \frac{{K}_{IC}^{healed}}{{K}_{IC}^{virgin}} \times 100$$

where η is the healing efficiency expressed in percentage, while K_{IC}^{virgin} and K_{IC}^{healed} are the virgin and healed mode-I fracture toughnesses, respectively.

### Self-Sensing and Automation

Serial communication between a compact spectrometer and laser/TEC controller coupled with the logic of an ATMEGA328P micro-controller enables healing to progress without human intervention. Three distinct states exist during a sample life-cycle. An initial sensing state regularly polls the spectrometer for real-time irradiance readings and compares against an initial baseline until fracture is detected by the transmission dropping below a specified threshold. The ensuing resting state allows sufficient time for sample unloading and fluid delivery. The final healing state switches power from the sensing laser to the dosing laser to initiate in situ photopolymerization, thereby healing the fracture damage.

### Fluorescence Microscopy

Optical micrographs are captured using a stereo microscope (Axio Zoom.v16, Zeiss) equipped with a color microscope camera (AxioCam350, Zeiss). Fluorescent excitation is provided by a mercury arc lamp (HXP 120V, Zeiss) coupled with a mounted filter cube (DAPI/Fluorogold 49025, Chroma).

### Raman Spectroscopy

Spectroscopy is performed on films excised from post-fractured TDCB specimens with a confocal Raman microscope (XploRA Plus, HORIBA, Inc.) utilizing a 50× objective. A total of five scans, each with a 30 s acquisition time, are taken in the 200 to 2000 cm⁻¹ range at each location. Healed films are excised by scraping a piece of sharpened epoxy across the crack plane to avoid damage to the underlying thermoset matrix.

### Thermo-Mechanical Testing

Dynamic mechanical analysis (DMA) is performed on 15 mm long POF sections comprising a 10 mm gage length between end-mounted paper tabs secured with cyanoacrylate adhesive (Ultra Gel Control Super Glue, Loctite, Inc.). A dynamic mechanical analyzer (Q800, TA Instruments, Inc.) with a film tension clamp applies an oscillating strain of 0.25% at 1 Hz frequency following an initial preload of 0.05 N. A temperature sweep from RT to 150° C. is conducted at a ramp rate of 2° C. min⁻¹ while storage modulus (E′), loss modulus (E″), and tan(0) data are collected at a sampling rate of 0.5 Hz.

### Example 2: Photochemistry Development, Ex Situ Healing, and Optical Fiber Characterization

Achieving rapid and high fracture recovery with a one-part liquid photo-chemistry requires: low viscosity for swift and complete crack plane coverage along with sufficient adhesion of the polymerized healing agent to the host epoxy matrix. Moreover, visible-light polymerization under ambient conditions is desirable for real-world implementation. While free-radical photo-chemistries generally exhibit faster cure kinetics than cationic systems, the latter route was selected to over-come common limitations of the former. Namely, incomplete cure due to oxygen inhibition, appreciable shrinkage, and poor bonding to epoxies with typical acrylated compounds.

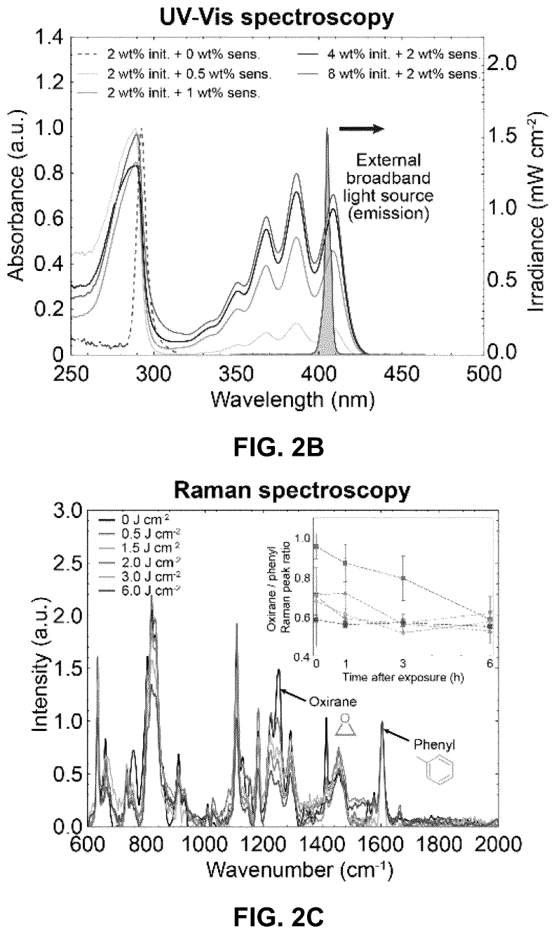

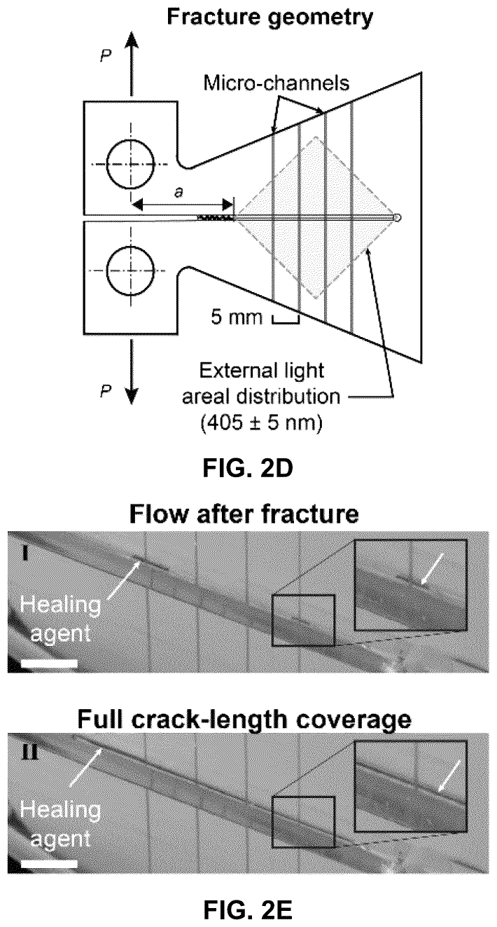

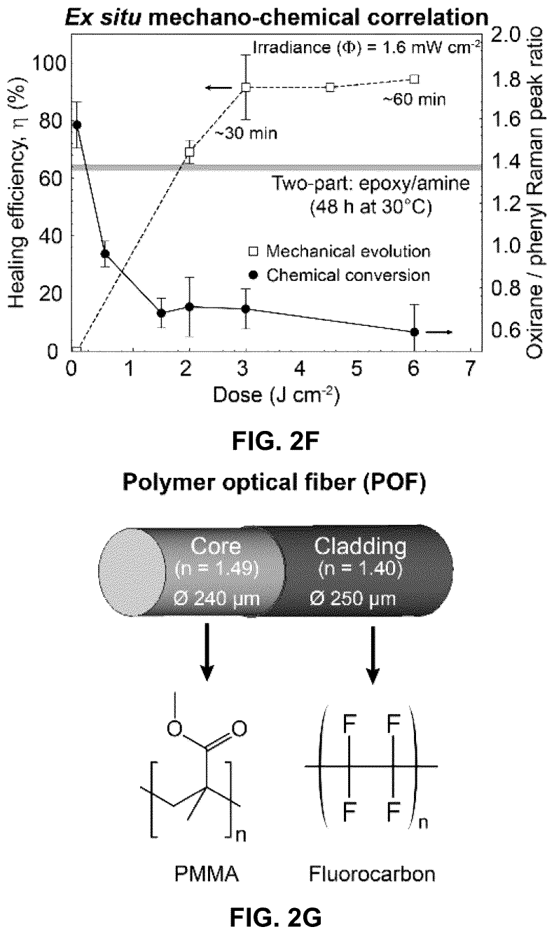

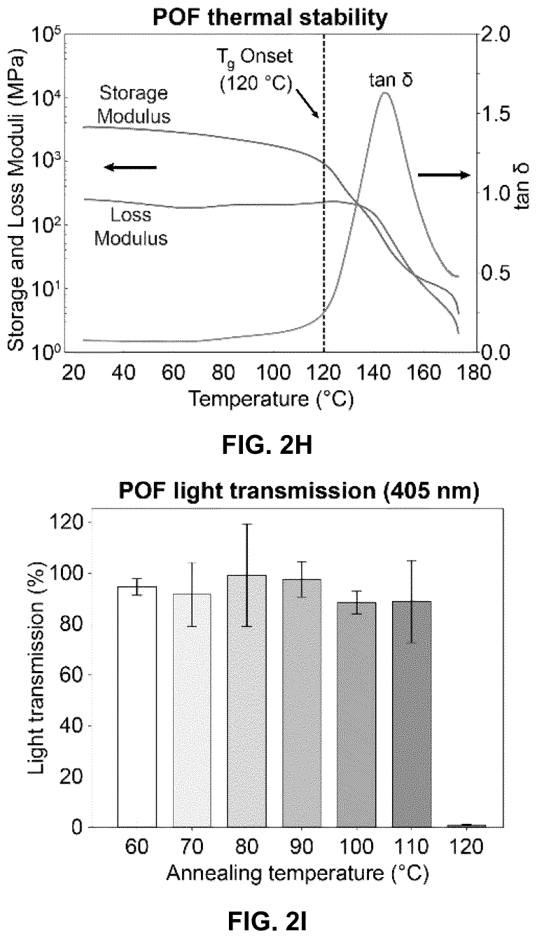

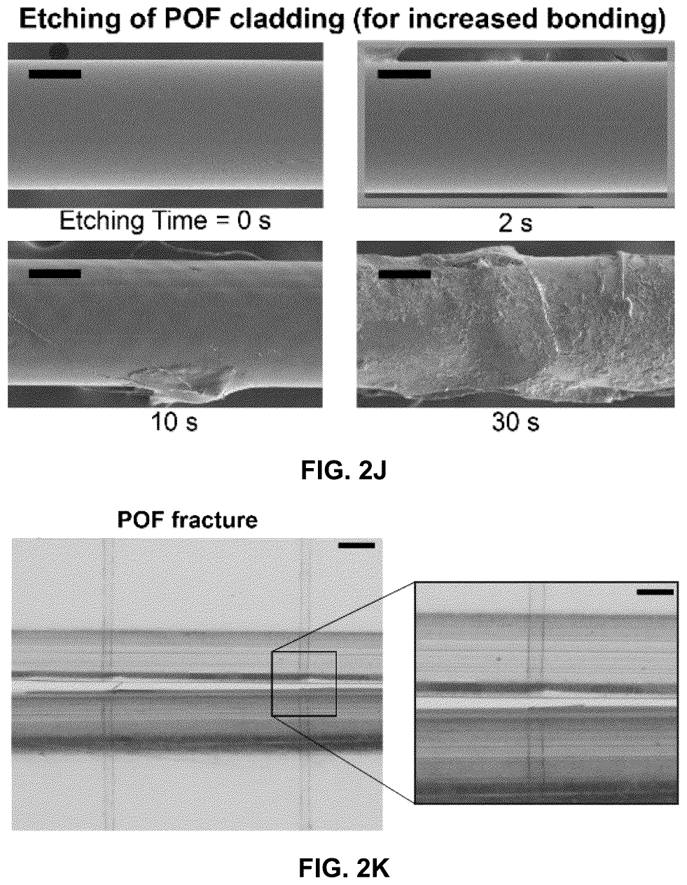

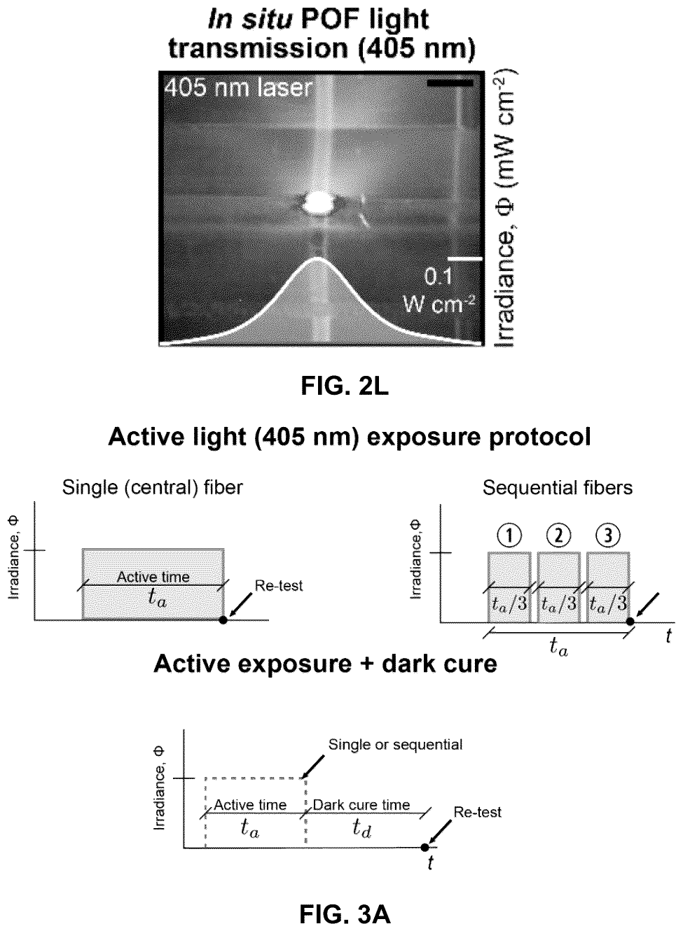

The specially formulated cationic photo-chemistry healing agent employs four distinct chemical moieties (FIG. 2A): (I) a base monomer of diglycidyl ether of bispehnol A (DGEBA) with reactive viscosity reducer 1,4 butanediol diglycidyl ether, (II) a phase-separated star block copolymer (Fortegra™ 100) toughening agent to increase fracture toughness, (Ill) a diphenyl iodonium salt photoinitiator that drives ring-opening polymerization of the dual monomers via protonic photo-acid generation, and (IV) a 9,10-diethoxyanthracene sensitizer that extends photo-chemistry light absorption from the UV spectrum into the visible region—initiating photolysis via electron transfer—to enable rapid photo-conversion without degrading the surrounding matrix. A wavelength of 405 nm is selected that coincides with commercially available light sources (e.g., Blu-ray laser diode). Initiator and sensitizer concentration is tuned to maximize absorption—assessed via UV-Vis spectroscopy (FIG. 2B)—and minimize viscosity, which is critical for efficient autonomic fluid delivery via microvasculature. A 4 wt % photoinitiator and 2 wt % sensitizer combination was ultimately selected, above which modest gains in absorbance are offset by increased fluid viscosity. Raman spectroscopy is employed to understand photochemical conversion as a function of light dose (i.e., irradiance×exposure) at the target wavelength. A first series of spectra (FIG. 2C) are obtained from the cationic photochemistry immediately after dosing by a broadband light source fitted with a focusing lens and band-pass filter (405±5 nm). The spectra are normalized using the non-reactive phenyl peak (1610 cm⁻¹) to overcome Raman acquisition variations (e.g., light intensity fluctuations). The amount of photopolymerization is quantified by calculating the ratio of the peaks corresponding to the reactive oxirane group (1252 cm⁻¹), which is consumed during the reaction, to the invariant phenyl group. The oxirane/phenyl peak ratio progresses from 1.6 in the unexposed liquid chemistry to 0.6 after 6 J cm⁻² of active light exposure. A subsequent series of measurements are taken to investigate a feature of cationic photochemistries whereby continued polymerization occurs after removal of the light source (i.e., dark cure) due to continued diffusion of the protonic photo-acid and respective ring-opening reaction of the oxirane group. For the lowest dose applied (0.5 J cm⁻²), a peak ratio of 1.0 immediately after light removal continues to decrease reaching the full ambient conversion ratio of 0.6 after 6 h (FIG. 2B, inset). This dark cure capacity highlights another advantage of the disclosed cationic photochemistry where light exposure can be minimized without continuous energy input.

To evaluate the ability of the photochemistry to repair (i.e., heal) cracks, mode-I fracture experiments are conducted using the well-established tapered double cantilever beam (TDCB) shown in FIG. 2D. For the TDCB geometry, fracture toughness is independent of crack-length—which is particularly important here and for liquid-based self-healing systems in general—since the healed crack length can vary based on fluid distribution and extent of polymerization. In this study, the TDCB was modified to contain internal micro-channels where the diameter (220 μm) is determined from the Young-Laplace equation to retain liquid healing agent before fracture, and to autonomously release afterwards. TDCB specimens with internal micro-channels exhibit no statistical difference in mode-I fracture toughness (K_{IC}) compared to neat (i.e., plain epoxy) specimens. Ex situ healing experiments are conducted by first filling the four micro-channels with photo-chemistry followed by tensile pin loading of the TDCB at a rate of 5 μm s⁻¹ until complete crack propagation to a circular crack-stop that is pre-drilled into the specimen, which ensures registration of the fractured interfaces after unloading to zero cross-head displacement. FIG. 2E shows the fluid delivery within the crack plane immediately after crack closure (top image) and after some time to ensure full crack-length coverage (bottom image); the wait time varies between 5-10 minutes depending on local fracture topology. After complete fluid fill, the TDCB is dosed within the load frame using a broadband light source coupled with a band-pass filter (405±5 nm) that provides uniform light exposure of 1.6 mW cm⁻² to the region depicted in FIG. 2D. The healed samples are then retested via tensile loading until fracture. Healing efficiency (1) is calculated as the ratio of healed fracture toughness (K_{IC}^{healed}) to virgin fracture toughness (K_{IC}^{virgin})), which for the TDCB geometry, simplifies to a ratio of healed to virgin peak loads (or average(s) of peak loads for multiple fracture events within a loading cycle). The ex situ healing results in FIG. 2F show that fracture recovery initially linearly increases with light dose, where a plateau healing efficiency of η=91.5±0.5% is reached at 4.5 J cm−2 (≈30 min at 1.6 mW cm⁻² intensity) indicating no further gains in fracture recovery at ambient conditions. Control samples with photo-chemistry delivered via micro-channels, but without light exposure, do not exhibit any recovery above measurement noise. For comparison with prior two-part healing studies, TDCB experiments are conducted using a the same epoxy/amine system pre-mixed at stoichiometry and auto-delivered via micro-channels, which recovers only 64% of the virgin fracture toughness after curing in an oven at 30° C. for 48 h. For the faster and more effective photo-based healing system, the evolution in mechanical recovery inversely correlates with the chemical conversion (i.e., oxirance/phenyl ratio) measured via Raman spectroscopy (FIG. 2C). Thus, this set of ex situ healing experiments establishes a benchmark for the maximum level of recovery that can be expected for subsequent in situ self-healing via embedded optical fibers.

Achieving in situ self-healing requires targeted light delivery at the damage location (i.e., crack plane). Optical fibers are selected for this purpose, which are able to transmit light via total internal reflection by having an exterior cladding with lower refractive index than the core, ergo light will leak where the fiber (cladding) is fractured. Silica-core fibers—mainstays of the tele-com industry—are initially considered, but the low defect-density and thermally-induced residual stresses during epoxy curing produced stochastic fracture behavior. Polymer optical fibers (POFs) provide a favorable alternative to silica fibers, whereby the acrylic core Eska™ POF selected for this study has thermo-mechanical properties more similar to the host thermoset with only twice the light attenuation of silica fibers at the target wavelength (405 nm). Specifically, the multi-mode POF comprises a 240 μm diameter poly(methyl methacrylate) (PMAA) core and 5 μm thick proprietary fluoropolymer cladding (FIG. 2G). Two POF-related aspects are critical to successful in situ light delivery: (1) preserving POF light transmission after embedding within the epoxy matrix that requires elevated temperature curing to develop host thermo-mechanical integrity, and (2) ensuring sufficient adhesion at the fiber-matrix interface to ensure that the POF fractures at the epoxy crack plane and no slippage (i.e., debonding) or out-of-plane fiber failure occurs. Dynamic mechanical analysis (DMA) is conducted to characterize the POF thermo-mechanical response via a temperature sweep from room-temperature (RT) up to 180° C. (FIG. 2H). A significant loss in POF storage modulus occurs after onset of the glass-transition temperature (T_{g}) around 120° C. At temperatures below T_{g} onset, molecular realignment is still possible, whereby residual stresses during POF manufacture (i.e., drawing) are released. This molecular relaxation reduces both mechanical and optical anisotropy induced by the fiber drawing process. When the fiber is unconstrained, this relaxation produces a shrinkage strain that induces defects in the POF cladding, thereby reducing optical transmission. A pretension force of 0.25 N is sufficient to overcome thermally induced shrinkage and mitigate cladding defects.

Through differential scanning calorimetry (DSC) studies, an epoxy matrix cure cycle of 24 h at RT followed by 24 h at 100° C. is ultimately selected, which results in 99% degree of cure (DOC) and a T_{g}=117° C. measured via DMA. A POF light transmission study is also performed (FIG. 2I), using a 405 nm fiber-coupled laser diode input where the light output is measured using a spectrometer coupled to a 180° cosine-corrector showing 88.4±4.6% light transmission (with respect to the pre-exposed POF) is retained after 2 h at 100° C. Despite significant retention of light transmission, as-received POF do not fracture in the epoxy, but instead debond and bridge the TDCB crack plane, as a result of the low adhesion between the matrix and fluoropolymer cladding. To promote interfacial bonding, a sodium-based etchant is used to strip the fluorine groups from the carbon backbone and functionalize the cladding surface with organic carboxyl, carbonyl and hydroxyl groups for stronger adhesion to epoxy. An etching time of 2 s is enough to produce sufficient surface chemistry for POF fracture without inducing damage to the fiber cladding (FIG. 2J). Note, both POF surface functionalization and thermal-annealing are required to achieve consistent fiber fracture at the TDCB crack plane, i.e., etched but non-annealed fibers bridge the crack. Combining both thermal-annealing and chemical-etching engenders targeted in situ light delivery at the fracture surface with sufficient intensity to photo-polymerize the cationic liquid healing agent released from micro-channels.

Raman spectroscopy is used to assess photopolymer conversion as a function of radiant light exposure. A quantitative measure of photochemical conversion is obtained by monitoring the relative peak ratio of Raman shifts corresponding to oxirane and phenyl ring stretching modes (1250-1256 cm⁻¹ and 1604-1610 cm⁻¹, respectively). The invariant phenyl peak is used an internal standard to measure the oxirane during ring-opening polymerization. Liquid photochemistry is exposed to a prescribed dose (irradiance×time) up to 6000 mJ cm⁻² delivered by a broadband light source (Dymax BlueWave 200) with a 405±5 nm bandpass filter (EO #86-622).

The resulting peak ratios are found to vary from 1.6 in the uncured photochemistry to 0.6 in the fully cured photopolymer after doses above 3000 mJ cm⁻². An initially rapid drop in oxirane/phenyl is seen after a dose of 500 mJ cm⁻² owing to protonic acid generation and subsequently formed active centers (polymerization sites) readily consuming locally available monomer. At intermediate doses (500-2000 mJ cm⁻²) the consumption of oxirane slows due to an increase of system viscosity limiting protonic acid mobility. A further reduction in oxirane consumption is seen at high levels of conversion due to either active center termination or trapping of unreactive monomer. At doses corresponding to high rates of conversion (>2000 mJ cm⁻²) a significant reduction in the rate of oxirane consumption on account of increased system viscosity, leading to limited production of new active centers and trapping of those already produced.

Cationic photopolymerization is capable of continuing after the initiating light source has been extinguished. This continued polymerization or dark cure is afforded by the cationic active centers repelling each other, restricting the radical-radical termination responsible for the short active center lifetime of free-radical systems. Migration of these active centers allows for additional polymerization, known as shadow cure, outside the original light exposed area. Additional Raman spectroscopy studies are conducted to assess the dark cure behavior of the developed photochemistry. It can be seen in FIG. 20 that nearly all applied doses were able to reach full conversion after a single hour of dark cure, with the lowest dose (500 mJ cm⁻²) requiring 6 hours. Leveraging dark cure shows potential to further reduce the required energy input, while still performing 4× faster than prior two-part vascular studies.

### Example 3: In Situ Self-Healing/Self-Sensing

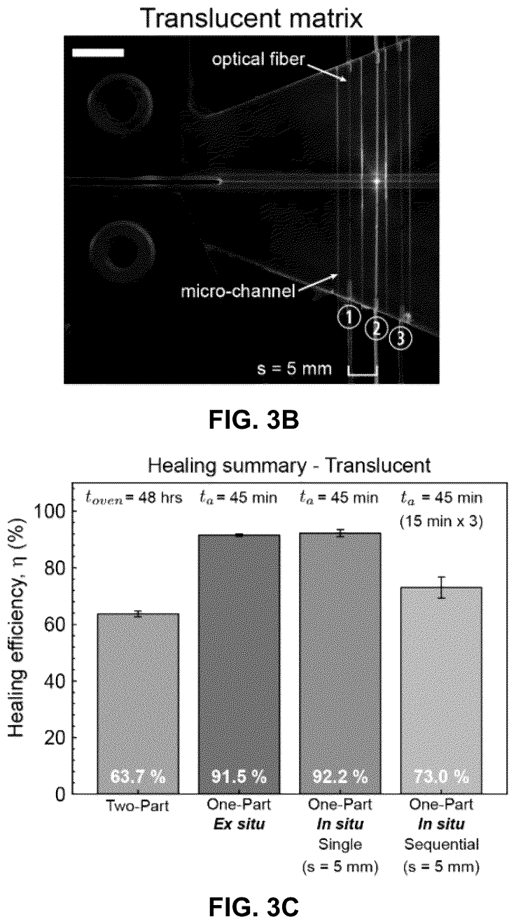

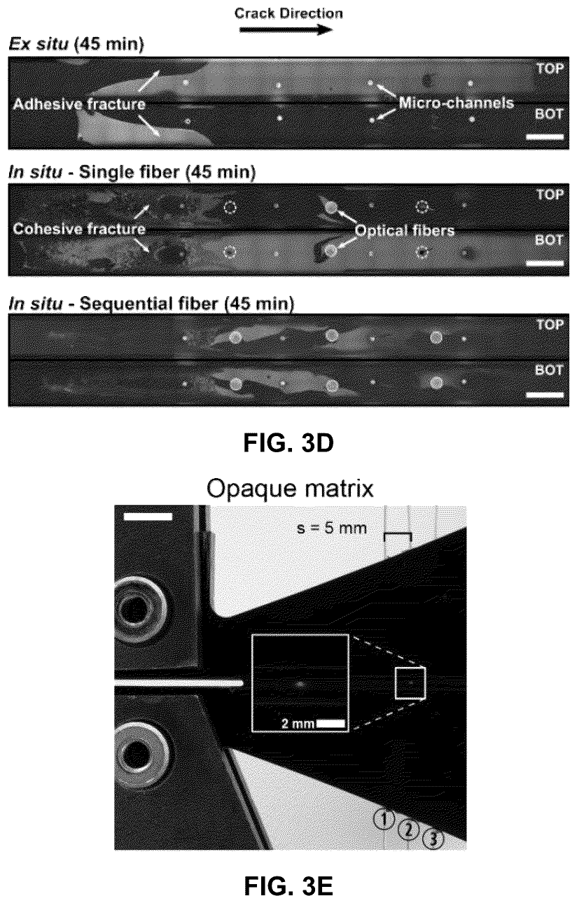

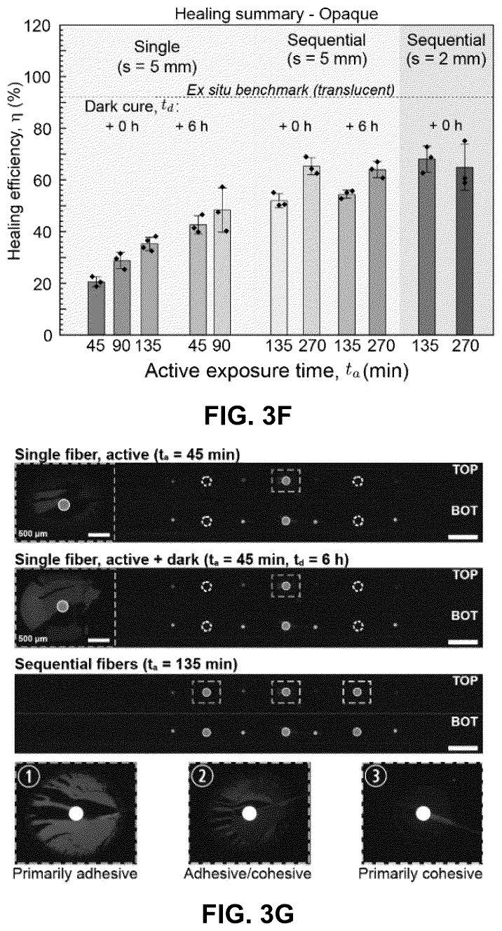

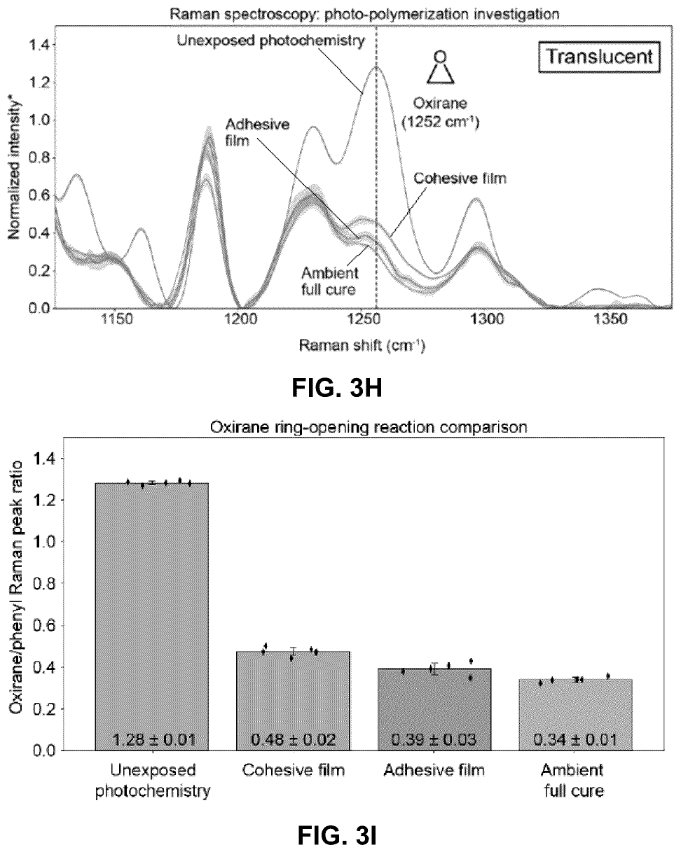

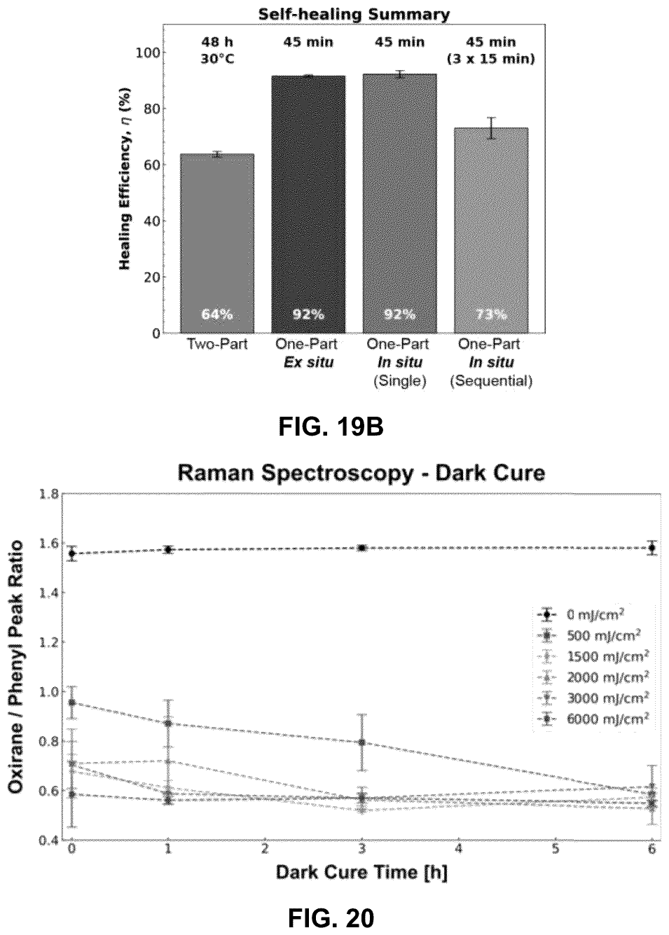

In contrast to ex situ healing via a broadband light source, in situ healing uses a 405 nm single-mode fiber-coupled laser diode to deliver high intensity light to fractured fiber surfaces and induce photochemical conversion of the delivered healing chemistry. Bare fiber terminators connect the other end(s) of embedded optical fibers to a spectrometer with a sampling rate of 2 Hz to enable continuous monitoring of intensity and transmission. In the in situ configuration, studies are performed to decouple the effects of both active cure and dark cure on the healed fracture response, with timescales kept equivalent to ex situ experiments for an exposure-equivalent comparison. In situ healing via active light exposure alone (i.e., no significant dark cure) is achieved using two schemes (FIGS. 3A, 19A-19B) for light delivery following fracture and photochemistry infiltration: single fiber delivery and sequential fiber delivery. The devised healing schemes are implemented using a modified TDCB geometry comprising a translucent epoxy matrix, four evenly-spaced micro-channels, and three POF spaced 5 mm apart. These POF are positioned midway between the channels to achieve targeted light delivery proximal to the autonomically-released liquid healing agent upon fracture (FIG. 3B). In the single fiber strategy, light intensity is transmitted through the central POF at intensity (ϕ) for a prescribed active time (tₐ=45 min) to induce photopolymerization from one active exposure point. In the sequential fiber strategy, ϕ is held at the same value but light is trans-mitted through the three POF in succession for tₐ=15 min each. Transmission occurs in spatial order starting from the fiber nearest the crack mouth opening. This scheme is intended to provide a uniform light exposure along the propagated fracture, analogous to 3 POF being concurrently coupled to single active diode. Such coupling is not realized here due to the lack of a suitable multiplexed array. In these solely active cure strategies, dark cure is avoided via immediate re-fracture of samples following light dosing. The residual healing potential of the photochemistry following active exposure was assessed using an additional scheme mirroring single fiber delivery, with samples removed from the testing apparatus following active exposure and stored in darkness for a specified time t_{d} (FIG. 3A). Equivalent light intensity is ensured in all tests via normalization of ϕ at 200 mW cm⁻², measured in the absence of a TDCB sample to avoid inaccuracies die to attenuation in the POF. This normalization ensures typical “delivered” light intensities of 90-110 mW cm⁻² at the fracture plane.

Within translucent samples, light delivery is easily visualized through the fibers and inside the micro-channels. Fluorescence of the anthracene sensitizer in the sequestered liquid photochemistry indicates micro-channel exposure to incident light, likely from fiber side emission and optical interactions within the matrix. Despite these effects, (FIG. 3B) exemplifies the level of localized high-intensity light delivery at the fracture surface during single fiber exposure. Healing using single fiber in situ light delivery and tₐ=45 min (enough to reach the maximum ambient cure) shows that the developed photochemistry outperforms an established two-part epoxy-amine healing chemistry benchmark (η≈92% vs 64%) while polymerizing 50× faster and requiring no significant external stimulus, i.e., heat from an oven (FIG. 3C). Moreover, photochemistry healed using single fiber exposure displays nearly equivalent healing performance to the ex situ reference at commensurate exposure time, attributed to ≈100× greater irradiance at the fracture surface from waveguiding. Healing via sequential fiber exposure is comparatively worse (η≈73%) owing to the net photonic dose being lower per fiber target area vs single fiber exposure, though this still exceeds the two-part chemistry benchmark and maintains a 50× faster healing rate. Fluorescent microscopy of both ex situ and in situ samples—conducted on fully fractured post-heal specimens rinsed with ethanol to remove uncured photochemistry—reveals significant mechanistic information pertinent to fracture plane light scattering and photochemical state-of-cure. The cured photochemistry is inherently fluorescent, suggesting a possible damage inspection technique for real-world applications. Ex situ samples exhibit a uniform adhesive film (FIG. 3D) mimicking the uniform light distribution provided by the broadband source. This suggests broadband exposure renders maximum ambient cure in these samples, with accompanying high healing efficiencies correlating adhesive failure to a high degree of polymerization. Single fiber exposure in situ samples present a similar adhesive film near the emitting fiber which extends beyond the auxiliary POF. A single 250 μm POF can thus create a healed area 150× larger than itself, indicating that equivalent healing can be achieved at lower optical fiber placement densities. Mixed adhesive/cohesive failure proximal to the crack mouth opening suggests cure via protonic acid diffusion (i.e., shadow cure) at the periphery of the light distribution. This is further evidenced by the local transition to a “rain shadow” of uncured material emanating from the first microchannel, caused by uncured material being removed by the ethanol rinse. Conversely, sequential fiber exposure produces a markedly smaller adhesive film concentrated between the first and second fibers. This results from a combination of dark cure and extended exposure from fiber side-emission, though a “superposition” of light exposure potentially dominates at lower time scales. Contributions to this superposition effect include light exposure overlap (primarily in the adhesive region), protonic acid diffusion, and induced dark cure in previously exposed regions. Such “sequential” dark cure results from transitioning of active exposure between fibers during delivery, with already-exposed regions exhibiting protonic acid diffusion.

The pervasive fluorescence shown in FIG. 3B signifies that additional modes of scattering and absorption in both the matrix and fibers (e.g., side-emission) contribute to healing. However, this suggests exposure of retained photochemistry in the micro-channels, possibly inducing premature cure and precluding attainment of repeated damage/repair cycles. Additionally, such phenomena do not exist within opaque materials such as carbon fiber/epoxy composites (CFRP), rendering the translucent matrix healing studies potentially non-representative. To assess the effects of matrix translucency on healing, channel protection and light isolation are effectuated in TDCB specimens via opacification with light-absorbing carbon black (CB). The micro-channel and optical fiber configuration(s) are unaltered as compared to the translucent samples (FIG. 3E). A concentration of 0.05 wt % CB, incorporated into the epoxy matrix via mechanical blending, is chosen to ensure sufficient light absorption without impacting fracture behavior. This modification limits fluorescence to the vicinity of the emitting fiber despite complete infiltration of the fracture plane by liquid photochemistry, suggesting light blocking commensurate with an opaque material (FIG. 3E).

Repeating the translucent single fiber active exposure healing study in the opaque system reveals greatly reduced healing efficiency without dark cure (η≈20% vs≈92%; FIG. 3H). This is attributed to under-cure or non-cure of photochemistry released into the fracture plane outside the proximity of the fiber, given that light scattering effects outside the fiber vicinity are eliminated. Increasing active exposure time to tₐ=90 min and tₐ=135 min without dark cure enables slightly higher healing performance (η≈30% and η≈36%, respectively), indicating that limited scattering phenomena are retained in both the fiber and photochemistry. However, healing performance plateaus rapidly with as exposure time is increased, further proving that healing effects due to scattering are minimal. Adding a dark cure time of t_{d}=6 h to single fiber active exposure times of tₐ=45 min and tₐ=90 min produces a net healing performance gain of Δη≈22% and Δη≈20%, respectively, confirming the importance of latent curing potential in opaque host materials.

Sequential exposure healing tests in an opaque matrix produce markedly better healing results than single-fiber exposure for equivalent values of tₐ=45 min and tₐ=90 min with t_{d}=0 h as η increases to≈50% and ≈68%, respectively (FIG. 3H). No statistically significant change in healing efficiency occurs with the addition of dark cure, indicating that the active light exposure proximal to each fiber dominates the cured response. The negligible benefit from additional dark cure time suggests impeded protonic acid diffusion between actively-exposed (fully cured) regions, likely by excessive species consumption during initial conversion. Thus, diffuse light excitation (at low reactive species cost) cannot enable dark cure far from the fiber. Halving the fiber spacing showed no improvement at either tₐ=45 min or tₐ=90 min, confirming a limit to diffusion-dominated healing.

Post-fracture fluorescent microscopy studies of opaque samples healed using single fiber exposure (tₐ=45 min) show that cured material (and thus healing) is largely concentrated around the central (emitting) fiber (FIG. 3G). Failure is largely cohesive without dark cure (t_{d}=0 h), indicating sub-maximum cure and accounting for the low measured healing efficiency (η=22%). Dark cure (t_{d}=6 h) results in the transition to a largely adhesive failure mode and increases the healing efficiency to η=44%. Thus, relative influence of latent cure potential in opaque systems may be pronounced where optical conduit density is limited. Fluorescent microscopy of sequentially-exposed opaque specimens (tₐ/3=45 min) confirms these findings, with a transition in failure modes observed between the regions nearest of the three fibers. This transition results from the active cure time of subsequent emitting fibers becoming the dark cure time for previous ones (td=90 min, 45 min, and 0 min for fibers 1, 2, and 3, respectively).

Raman spectroscopy is used to assess the relative degree of chemical conversion between adhesive and cohesive failure regions (FIG. 3H) using the invariant phenyl to reactive oxirane peak ratios as in FIG. 2C. Cohesive (2.5 J cm⁻² dose) and adhesive (4.5 J cm⁻² dose) films are excised from post-in situ self-healing specimens with a translucent matrix to avoid signal pollution from

the underlying DGEBA-based thermoset. As compared to the fully-cured reference film (7.5 J cm⁻² dose) peak ratio of 0.34, the adhesive film peak ratio of 0.39 indicates a similar degree of chemical conversion, i.e., cure, especially when viewed in the context of the unexposed photochemistry peak ratio of 1.28. The cohesive film samples show a significantly reduced degree of conversion relative to the adhesive films (peak ratio 0.48), suggesting that the topological evidence correlating to increased healing performance has meaningful chemical underpinnings.

Building upon the developed opto-vascular self-healing methodology, an orthogonal transmission-based sensing modality is realized via supplementation of the 405 nm healing laser diode with a second sensing laser diode at 660 nm. The sensing laser wavelength lies outside the absorption spectrum of the photochemistry and thus enables transmission monitoring without initiating photopolymerization. Transmission monitoring of each laser is achieved using the same spectrometer and 2 Hz sampling from the healing studies, with coupling to the optical fiber section opposite the emission side. Manifestation of these complementary functionalities thus enables, for the first time, a combined autonomous healing/sensing modality capable of multiple healing cycles in a structural thermoset. To support such function in singular samples, a translucent TDCB geometry is devised comprising two micro-channels for photochemistry retention and delivery which are spaced 7.5 mm on either side of a single, central optical fiber for light transmission during both sensing and healing. Because successive healing cycles in a single specimen would require greater photochemistry volume than the micro-channels can sequester, permanent nozzle connections to an external liquid photochemistry reservoir are created. While the reservoir provides a functionally unlimited supply of liquid photochemistry, the nozzles are several mm in diameter at the connection point and thus preclude greater micro-channel density within the devised samples. To protect sequestered photochemistry from premature cure due to light scattering effects in the translucent matrix, the two present micro-channels are sheathed by a 200 μm thick CB film about their circumference. This annular film is sufficient for near-total absorbance of all incident light and is realized by first fabricating TDCB specimens with the optical fiber present but a 660 μm diameter PTFE monofilament in place of each channel. After the primary curing cycle of 24 h at 100° C. is complete, each 660 μm monofilament section is replaced with 220 μm PTFE monofilament which is centered in the vascule and tensioned with 25 g of weight to ensure concentricity of the vascule and CB film. This film is created by infiltrating the annular gap between the secondary monofilament and larger initial channel with 1 wt % CB-loaded epoxy resin, which is cured with a subsequent reduced temperature cure cycle (12 h at 70° C.). Following cure, the 220 μm monofilaments are removed and the resulting micro-channels are filled with liquid photochemistry. Though required for channel protection, this secondary thermal treatment results in minor occlusions and additional attenuation in the optical fiber and requires adjustments to diode intensity to produce the target ϕ≈100 mW/cm² at the fracture plane during both healing and sensing.

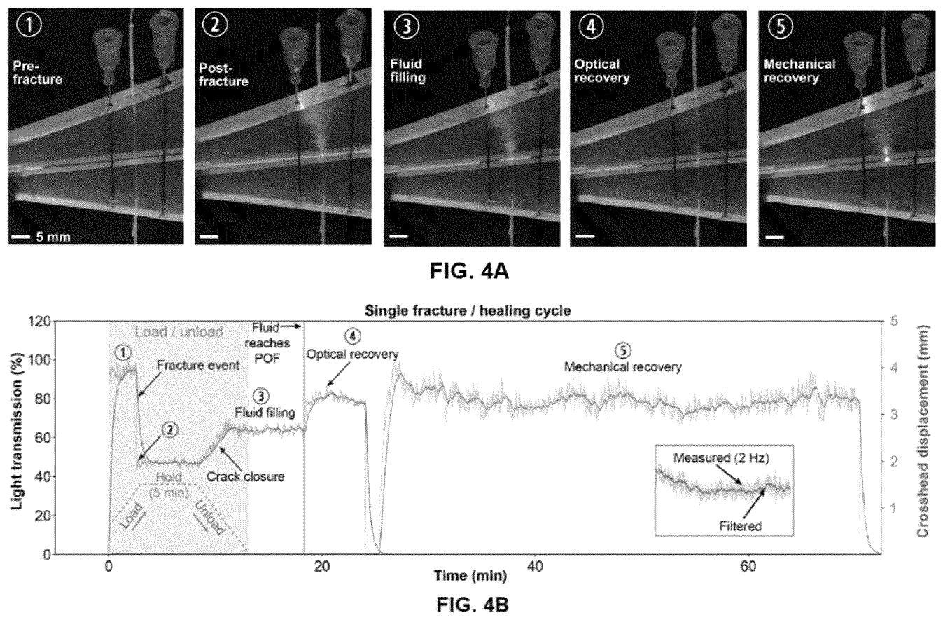

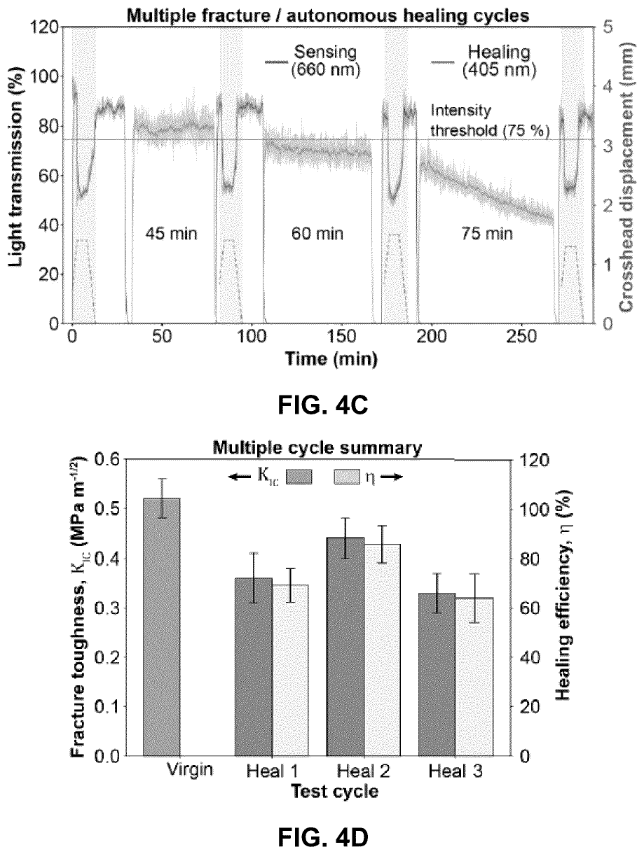

The combined optovascular self-sensing/self-healing modalities were first proofed manually, with human intervention required to switch between the sensing and healing laser emissions at specified periods. Prior to mode-I fracture, the sensing laser emits through the TDCB embedded optical fiber (FIG. 4A, inset 1). Upon fracture of the matrix and optical fiber, diffuse scattering of the sensing laser through the translucent matrix is observed as waveguiding is precluded (FIG. 4A, inset 2). Concurrently, autonomic vascular release of liquid photochemistry from the microchannels occur as samples are held at the maximum crosshead displacement for 5 min following fracture to assist this fluid delivery. Subsequently, the samples are unloaded to a zero crosshead displacement configuration and capillary forces drive fluid filling of the fracture plane (FIG. 4A, inset 3). Upon complete wetting of the fracture surfaces, a recovery of transmission is observed due to index matching of the liquid photochemistry with the separated optical fiber halves (n_{core}=1.49, n_{cladding}=1.40, n_{liquid photochemistry}=1.52) (FIG. 4A, inset 4). Following complete fracture plane wetting, the sensing laser is turned off and the healing laser is turned on for tₐ=45 min to cure the photochemistry and preserve the restoration of transmission (n_{cured photopolymer}=1.56) (FIG. 4A, inset 5). As in the initial translucent matrix single fiber exposure studies (tₐ=45 min, t_{d}=0 h), secondary scattering/absorption mechanisms in the matrix and fiber produce a favorable light distribution associated healing response across much of the fracture plane, though not proximal to the CB-protected channels. Following healing, the emission source is again switched to the sensing laser to reset the sensing/healing cycle.

The monitoring of this process via continuous light transmission measurement is shown in (FIG. 4B). Upon fracture, a marked drop in transmission from 100% to 50% occurs, concurrent with triggered vascular release. Upon crack closure following fluid delivery, transmission is restored to 70% via proximity of fractured optical fiber cross-sections. As capillary forces drive wetting of the fracture plane with liquid photochemistry, further transmission recovery to 80% occurs due to index matching of the liquid photochemistry and fractured fiber, though a subsequent minor decrease occurs as fracture plane infill completes. The emission source is then switched to the 405 nm healing laser, which shows relatively constant transmission during photochemical cure.

Using the developed fluid delivery and transmission monitoring indicators, complete automation of the damage sensing, triggered healing, and restoration monitoring process is achieved using an Arduino microcontroller. This microcontroller interfaces with the spectrometer, both laser sources, and load frame used for fracture testing. During sensing laser emission in a pristine sample, fracture is indicated by a 75% drop in the received transmission signal. This triggers a 5 min hold at the maximum displacement configuration, followed by a 7 min hold during crack closure and another 5 min to enable fracture plane wetting before the emission source is switched to the healing laser. The displacement hold helps to hasten crack plane wetting and occurs at a slower rate due to reduced channel count for automated samples.

Continued test cycling results in degradation of realized healing laser transmission, correlating to a reduction of 405 nm transmission in full-cured films (assessed via UV-Vis spectroscopy) due to photo-darkening effects. To overcome this obstacle and provide nearly-equivalent light exposure to the photochemistry during repeated healing cycles, active exposure time is in-creased from the initial tₐ=45 min in 15 min increments for each subsequent test (FIG. 4C). This modified active exposure strategy thus allows for the first demonstration of repeated fully autonomous healing/sensing damage cycles in a structural material, with the number of repeated cycles being limited only by available liquid photochemistry volume and potential vascular flow blockages. Three consecutive healed fracture tests following an initial virgin fracture show healing efficiencies in excess of 60% (FIG. 4C), with residual protonic acid in the fracture plane from previous healing benefiting subsequent cycles and offsetting the loss of beneficial exposure modes such as fiber side emission (absorbed by the CB channel perimeter) as a result of sample design criteria. This demonstration of repeated co-functionality marks tremendous progress in the active health monitoring and self-healing of structural thermoset materials, with potential applications extending to ubiquitous high-performance materials such as fiber-reinforced polymer matrix composites.

### CONCLUSION

The novel coupling of self-healing and self-sensing approaches achieved herein via optovascular augmentation of structural thermosets holds significant promise for incorporation into future structural materials. Concentration of these functionalities into a single matrix while transcending the limitations of prior self-healing approaches provides significant potential to pervade fiber-reinforced polymer matrix composites and address longstanding issues such as interlaminar de-lamination. Translation of the technology developed herein to composites would thus ensure the creation of safer and more sustainable infrastructure, especially with future investigation of functional aspects such as: (i) waveguides capable of withstanding the elevated cure temperatures of structural polymers and extreme environments and (ii) spectroscopic/interferomic techniques for improved in situ structural monitoring and system automation. Thus, the first repeatable and concurrent self-sensing/self-healing functionality while repairing damage up to 50× faster than prior approaches has been developed and demonstrated for the first time.

### Example 4: Further Experimental Details

### Photochemistry Formulation/Characterization

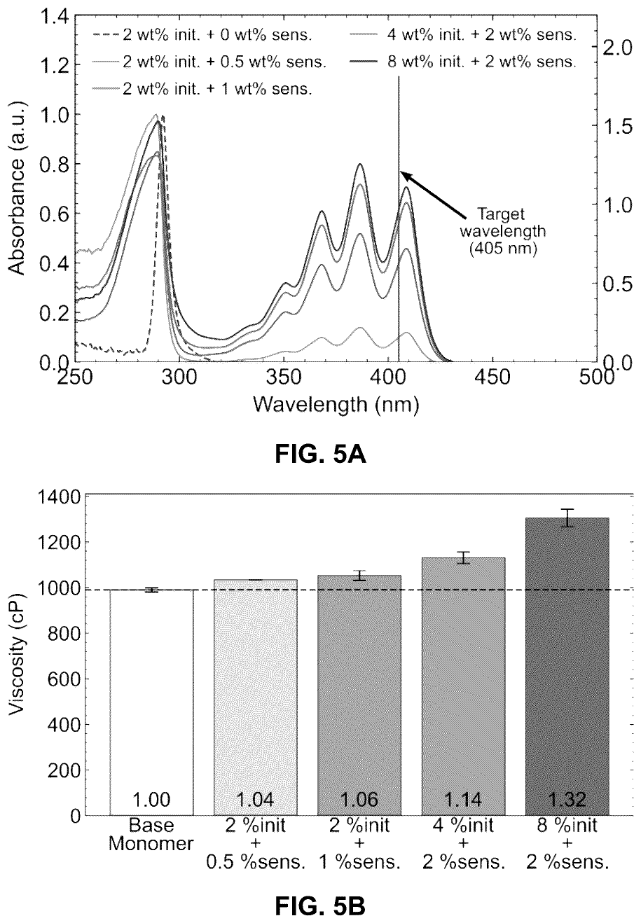

Formulation of the one-part healing agent central to the developed opto-vascular platform is chosen to maximize efficient use of photonic energy and minimize viscosity. Photopolymerization efficiency is assessed by comparing absorption at the target wavelength (405 nm) across candidate formulations via UV-Vis spectroscopy. A dual-beam UV-Vis spectrophotomoter (UV-2600, Shimadzu) measures absorption of each candidate chemistry from 190-900 nm. Liquid photo-chemistry is scanned between a microscope slide and cover slip with an empty slide/cover placed in front of the reference beam. Recorded absorption spectra (FIG. 5A) exhibit two distinct regions corresponding to the initiator and sensitizer. The iodonium salt photo-initiator forms a single peak near 290 μm that shows limited change between photo-initiator concentrations of 2 wt % to 8 wt %. In contrast, multiple peaks form in the visible light region with the addition of the anthracene sensitizer that drastically increase from 0.5 wt % to 2 wt %.

Fluid viscosity is a key parameter governing the vascular delivery rate of liquid healing agents within fracture regions. Therefore a lower viscosity is targeted to ensure rapid filling of the damage volume. Dynamic viscosity is calculated as the slope of the fluid shear response measured via a parallel-plate rheometer (Anton Paar). At low concentrations (5 wt %) of photoactive components little change is seen in agent viscosity. The strong increase in viscosity between 4 wt % and 8 wt % initiator suggests that system viscosity is primarily driven by initiator concentration. Given the correspondingly minimal gains in absorbance between these two concentrations, 4 wt % init. and 2 wt % sens. is ultimately chosen.

Approximately 18 g of the liquid toughened monomer system (EPNC-1, Spectra Photopolymers) is poured into a 20 mL scent vial covered in multiple layers of vinyl electrical tape to prevent unwanted light exposure (Scotch Super 33+, 3M). For the formulation primarily used in this study (4 wt % initiator and 2 wt % sensitizer), 0.38 g of the solid photosensitizer (Anthracure UVS 1101, Kawasaki Kasei Chemicals Ltd.) and 0.77 g of the liquid photoinitiator are added to the vial. The vial is then sealed and mixed with a vortex mixer (Thermo Scientific™ LP Vortex Mixer, Fisher Scientific) at 3000 rpm for 1 h. The mixed photochemistry is then left to sit for 12 h before being used in in situ healing experiments.

### Micro-Channel Sizing

Internal micro-channels are sized using the Young-Laplace equation:

$$h = \frac{2 γ cos θ}{ρ gr}$$

where h is the capillary height, γ is the surface energy, θ is the contact angle, p is the fluid density, g is gravitational acceleration, and r is the channel radius. Surface energy is determined by measuring capillary height of channels at varying radii. Contact angle is measured from optical images of photochemistry drops on an epoxy substrate using the ImageJ (v1.52s, NIH) image processing program.

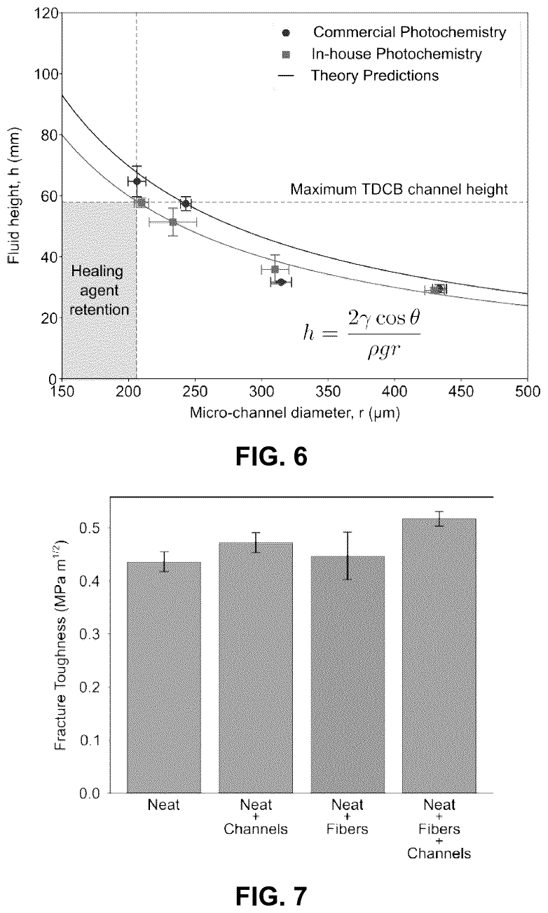

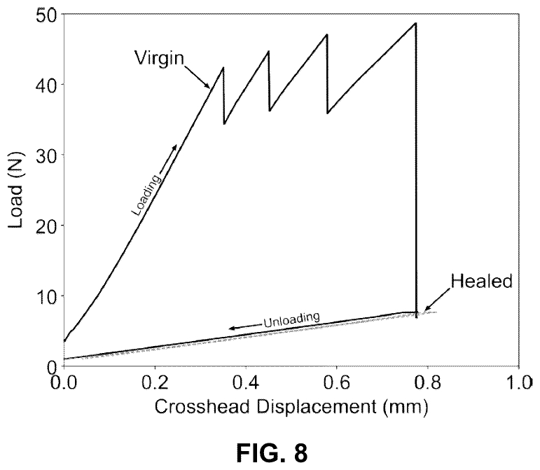

Channels are sized to retain both the in-house cationic photochemistry and a commercially available free-radical system (DYMAX 215-CTH-LV-UR-SC). System parameters (Table 1) are measured for each system to develop the calibration curves seen in FIG. 6. For a maximum TDCB channel height of 58 mm, a 220 km channel diameter is found to retain both healing agents.

TABLE 1
Measured Values for Micro-Channel Sizing

| Healing Agent | γ (dyne/cm) | ρ (g/cm³) | θ (°) |
|---|---|---|---|
| Cationic | 34.78 ± 4.89 | 0.93 ± 0.07 | 34.9 ± 1.6 |
| Free-Radical | 47.33 ± 2.28 | 1.05 ± 0.09 | 49.6 ± 2.9 |

### Effect of Tapered Double Cantilever Beam (TDCB) Geometry Modification on Mode-I Fracture Toughness

Realization of targeted healing agent and light delivery within a tapered double cantilever beam (TDCB) requires modification from the initial neat (i.e., monolithic) configuration. These modifications can affect the initial virgin fracture toughness that can influence the calculated healing efficiency complicating comparisons across sample sets. Therefore virgin mode-I fracture toughness is assessed to find the contributing effect of internal micro-channels, embedded optical fibers, and the combined fiber and micro-channel geometry—utilized for in situ healing. Results seen in FIG. 7 reveal a modest increase in fracture toughness from internal micro-channel inclusion acting as an obstacle for crack propagation. Embedded optical fibers show negligible change to system fracture toughness alone, however when combined with internal micro-channels contribute to a 20% increase.

### Healing Controls

Mode-I fracture healing controls are conducted to ensure that healing is occurring due to combined delivery of healing agent and light to the damage volume. Translucent in situ healing specimens containing four micro-channels and three polymer optical fibers (POF). Specimens are fractured and unloaded as specified in the main text. Laser only controls are tested without sequestered healing agent and undergo 45 min of active exposure from the 405 nm laser diode. Healing agent only controls contain liquid healing agent that is delivered to the damage volume but exposed only to ambient laboratory lighting. Under both conditions no healing is observed as evident by the equivalent slope during the virgin unloading and entire healing load and unload.

### Optical Fiber Integration—Polymer and Silica

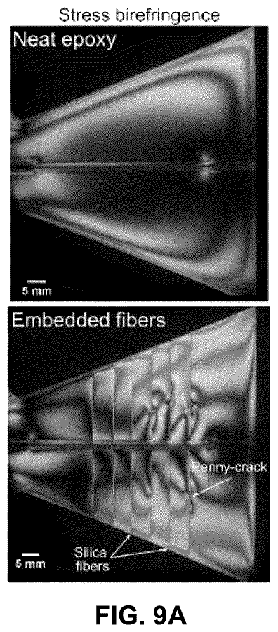

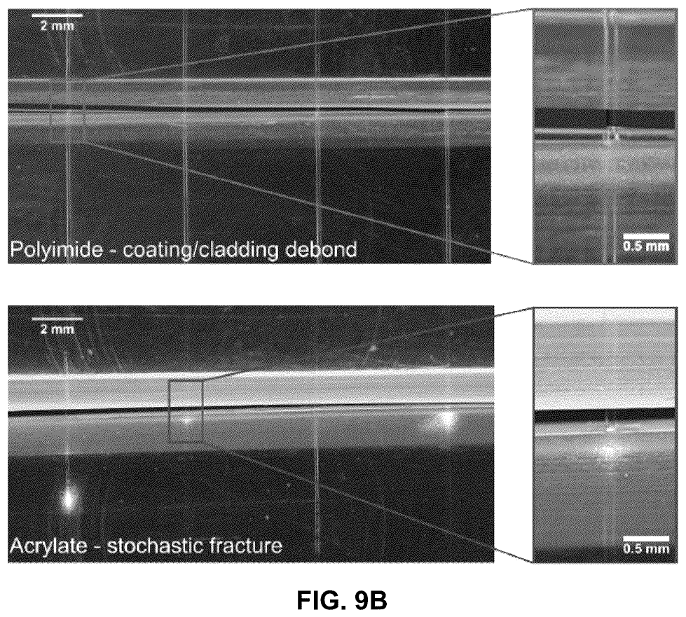

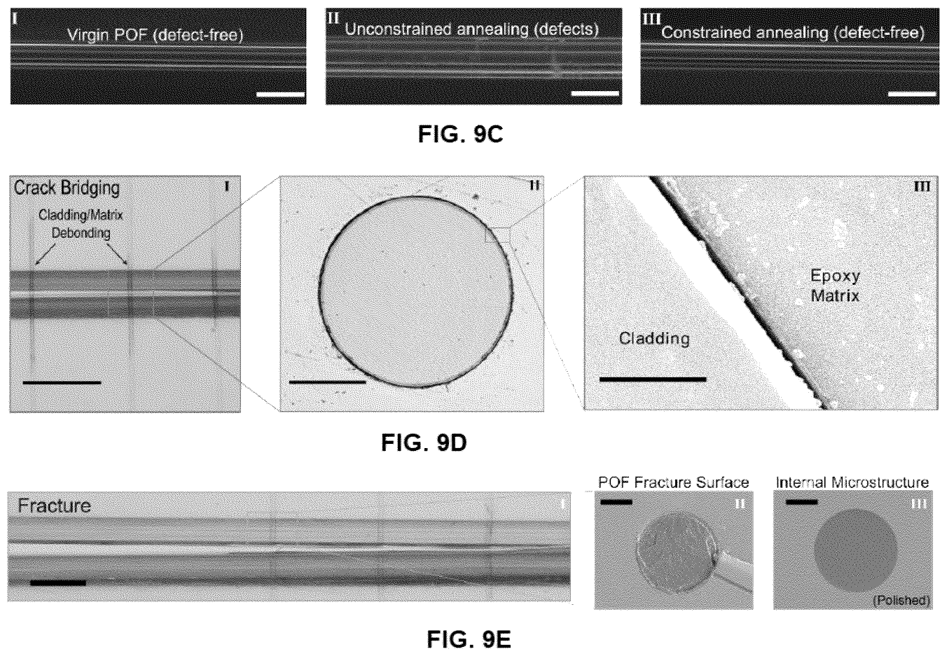

Initially, silica-core fibers are chosen for targeted light delivery at the fracture surface. However, a number of fabrication and experimental challenges proved difficult for practical implementation. For example, specimen fabrication requires great care to avoid fracture of the brittle silica fibers when separating the silicone mold halves. A large difference in thermal expansion between silica and the host thermoset leads to the formation of residual stresses that manifest as penny-cracks—annular fracture along the optical fiber—after cooling FIG. 9A. Polyimide-coated silica fibers exhibited fiber bridging across fracture surfaces due to debonding at the cladding/coating interface FIG. 9B. In contrast, acrylate-coated fibers display sufficient bonding to achieve fiber fracture. However, the characteristic low defect density of silica optical fibers meant fracture location of-ten occurred away from the thermoset fracture surface. A toughened (K_{IC}=1.95) matrix system achieved consistent fracture within the beveled region, however the loads developed obliterated the fiber fracture surface—inhibiting light delivery.

Successful integration of polymer optical fibers is achieved by balancing thermo-mechanical aging and chemical functionalization to ensure fracture and maintain optical transmission. Optical fibers are pre-tensioned with lead weights to overcome damage to the cladding driven by release of residual drawing strains at elevated temperatures FIG. 9C. Without chemical functionalization a weak interfacial bond forms between the fluorocarbon cladding and surrounding polymer matrix. During mode-I fracture experiments this reduced bonding drives matrix-cladding debonding/crack-bridging FIG. 9D. Combined thermal and chemical processing achieve consistent fiber fracture at the TDCB crack plane resulting in a near planar fracture surface and a lack of debonding even outside the etched region.

### Degree of Cure

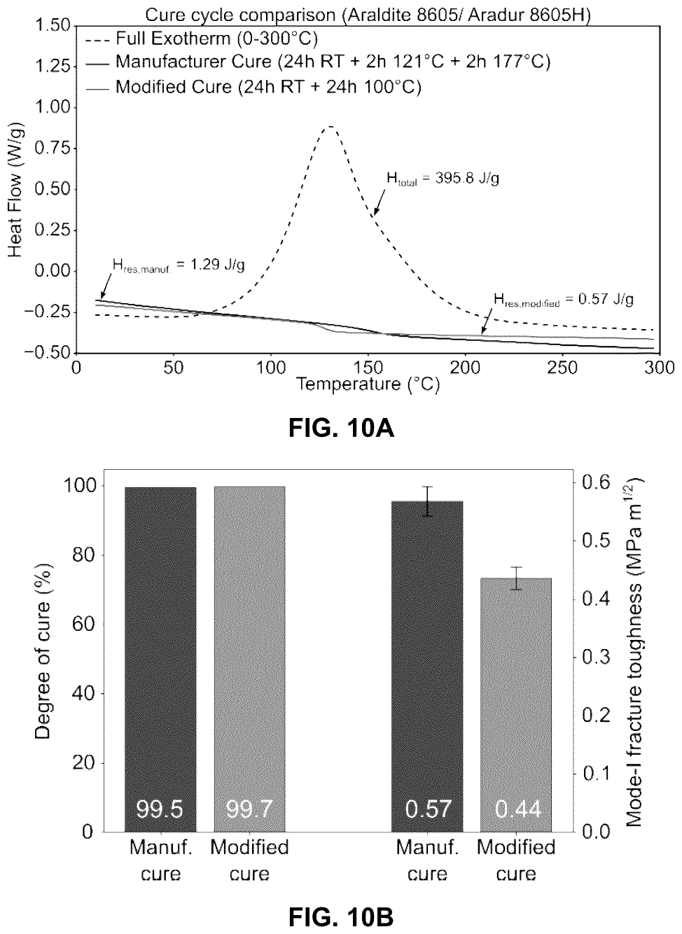

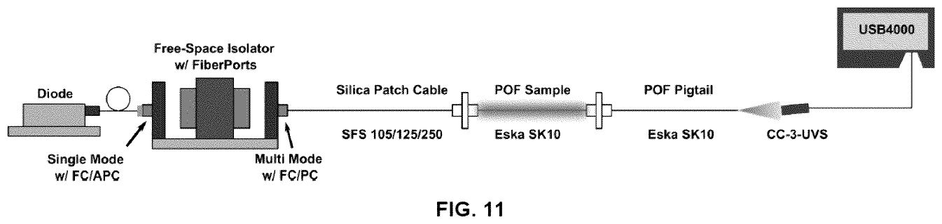

The aerospace-grade host thermoset requires a high temperature oven cure cycle (2 h at 121° C.+3 h at 177° C.) that exceed the service range of the embedded polymer optical fibers (POF). A modified cure cycle (24 h at 100° C.) is adopted to prevent POF degradation while allowing sufficient cure of the host thermoset. A TA Instruments Q200 differential scanning calorimeter (DSC) measures heat flow across a temperature sweep from 0-300° C. at a rate of 10° C./min. To remove residual thermal stresses samples undergo an initial quenching cycle where they are heated to 180° C. at a rate of 10° C./min and then cooled to 0° C. at 20° C./min. This cycle is necessary to avoid the presence of an endothermic peak at the glass transition that can impact the calculation of T_{g}. Heat flow of quenched epoxy samples (FIG. 10A) show no significant change to measured residual cure indicating minimal curing during the initial cycle. Degree of cure (α) is calculated with the following equation:

$$α = 1 - \frac{{H}_{res}}{{H}_{total}}$$

where Hᵣₑₛ is the residual heat of reaction measured in cured epoxy and Hₜₒₜₐₗ is the total heat of reaction obtained by performing a full temperature sweep on mixed epoxy and integrating heat flow with time:

$${H}_{total} = {\int }_{0}^{t} h ( t ) dt$$

The residual heat is measured after the onset of T_{g} where an exothermic peak—corresponding to energy released during cross-linking—appears in partially cured samples:

$${H}_{res} = {\int }_{{1}_{{T}_{g}}}^{t} h ( t ) dt$$

Results in FIGS. 10A-10B reveal minimal difference in the calculated degree of cure between the two cure cycles. However, an approximately 20° C. difference in T_{g} is observed. Despite the lack of residual heat in the modified cure cycle, mode-I fracture toughness is noticeably reduced when compared to the manufacturer recommended cycle. Future investigations are necessary to develop an opto-vascular platform capable of withstanding the high temperatures necessary for full fracture toughness development.

### In Situ Optical Setup

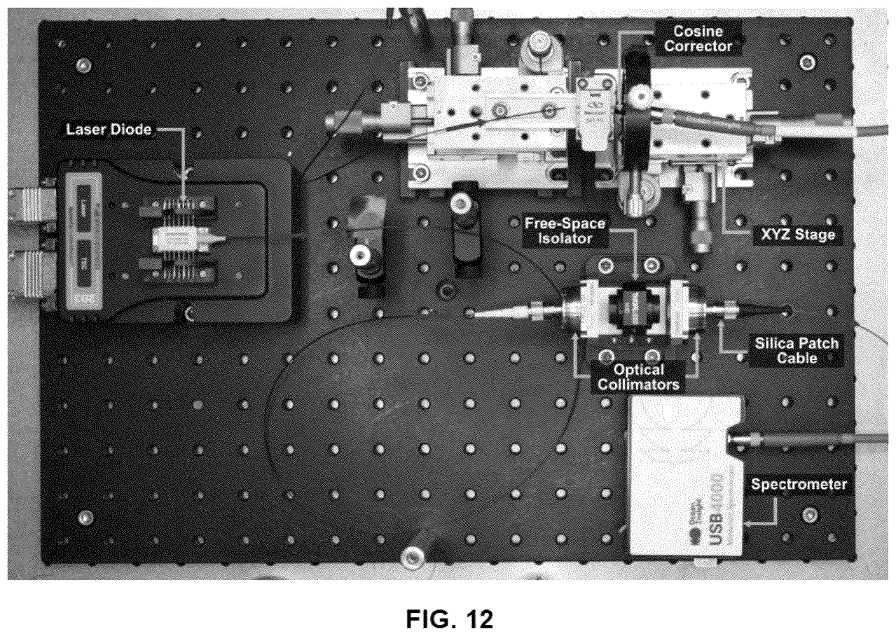

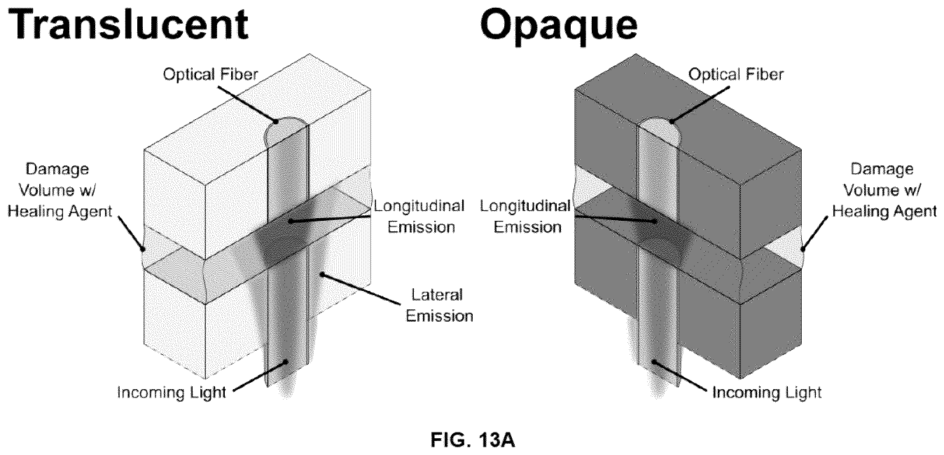

Absolute irradiance measurements and in situ dosing were carried out with the optical setup seen in FIG. 12. Light is provided by a single mode fiber-coupled laser diode (QFLD-405-20S, QPhotonics) driven by a low-noise laser diode controller (6301 ComboSource, Arroyo Instruments) coupled with a butterfly diode mount (203 LaserMount, Arroyo Instruments). A visible free-space isolator (IO-3D-405-PBS, ThorLabs) is placed inline to minimize reflections by 30 dB (99.9%). Collimated light is coupled to the isolator with an aspheric lens (FiberPort PAF2A-18A, ThorLabs) providing further protection due to an anti-reflective coating and angled FC/APC connector. Light is then collimated with an aspeheric collimator (FiberPort PAF2P-11A, ThorLabs) to a 2 m silica patch cable (SFS 105/125/250, FiberGuide) with FC/PC connectors (Fiber Instrument Sales). Connections to measured fibers were made with bare fiber terminators (BFT1, ThorLabs) featuring interchangeable ceramic ferrules for connections to 250 μm polymer optical fibers (B30270C, Thor-Labs) and 125 μm silica fibers (B30128C3, ThorLabs). A final connection is made to a polymer optical fiber (POF) pigtail, transmitting light to free space.

Free space absolute irradiance measurements are taken with a compact spectrometer (USB4000, Ocean Insight) using a VIS/NIR shielded fiber (QP400-1-VIS-NIR, Ocean Insight) and a cosine corrector with a spectralon diffuser (CC-3-UV-S, Ocean Insight). The face of the cosine corrector is angled 5° off axis to further minimize back reflections. No significant (<2%) change was found in irradiance measurements at this small angle. Alignment of the free-space end of the POF pigtail was accomplished with high precision fiber alignment stages (561D-XYZ, Newport Corp.) allowing relative movement between the cosine corrector and terminated fiber end. Movement is controlled by manual micrometer actuators with micron resolution (SM-06 and SM-13, Newport Corp.). Absolute irradiance is calibrated for VIS-Shortwave NIR (350 nm-1100 nm) with a radiometrically calibrated tungsten-halogen light source (HL-3P-CAL, Ocean Insight). Each spectra is captured by the manufacturer provided software (OceanView v1.6.7, Ocean Insight) with the parameters seen in Table 2. Integration time was adjusted before each reading to maintain the maximum power reading at 85% of the equipment's maximum range. Individual readings were taken between 344-1044 nm with 0.5 seconds between each reading.

TABLE 2
Software Settings for Spectrum Acquisition using
the USB4000 Spectrometer with OceanView Software

| Parameter | Value |
|---|---|
| Integration Time | Automatic |
| Scans to Average | 2 |
| Boxcar Width | 1 |
| Electric Dark | On |
| Nonlinearity Correction | On |
| Trigger Mode | On Demand |
| Decouple Correction | Off |

### Effect of Thermoset Opacity on Healing Efficiency

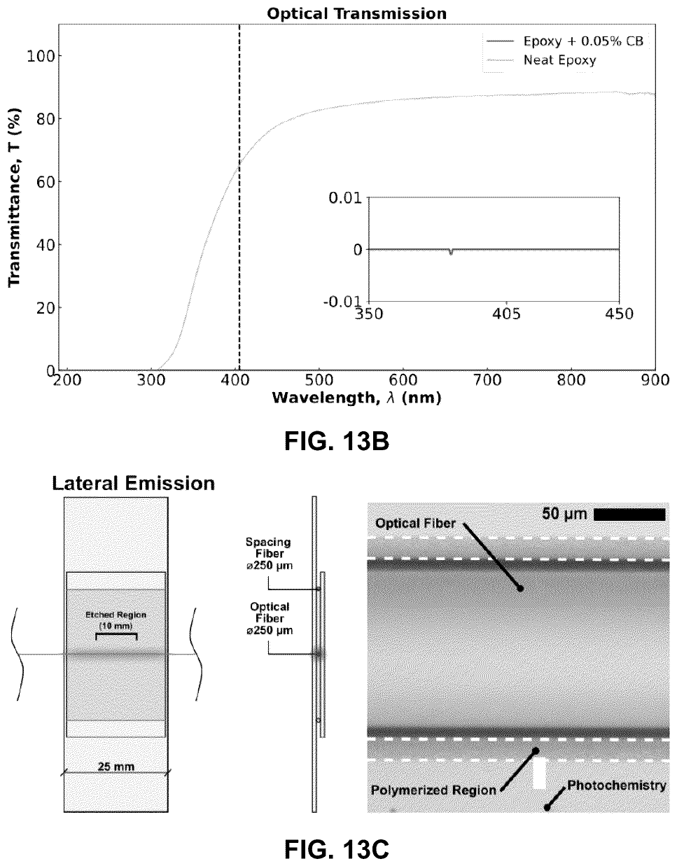

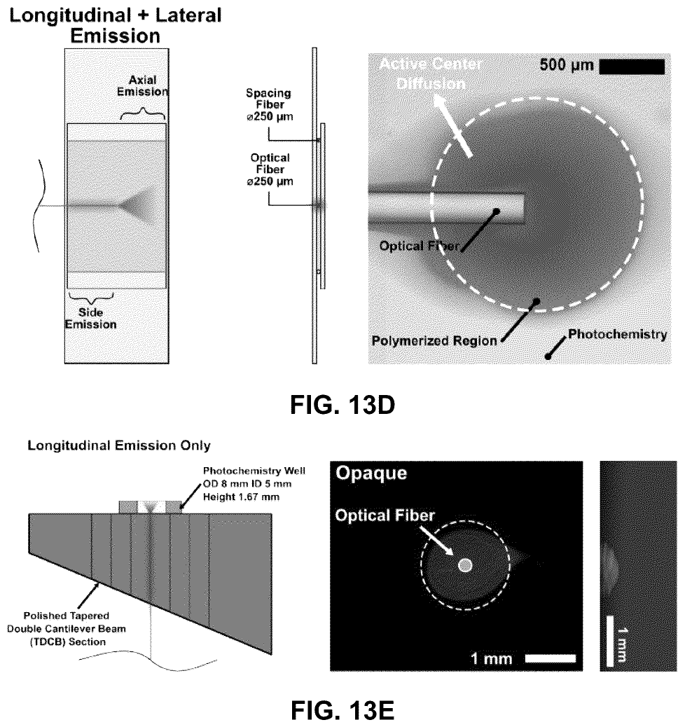

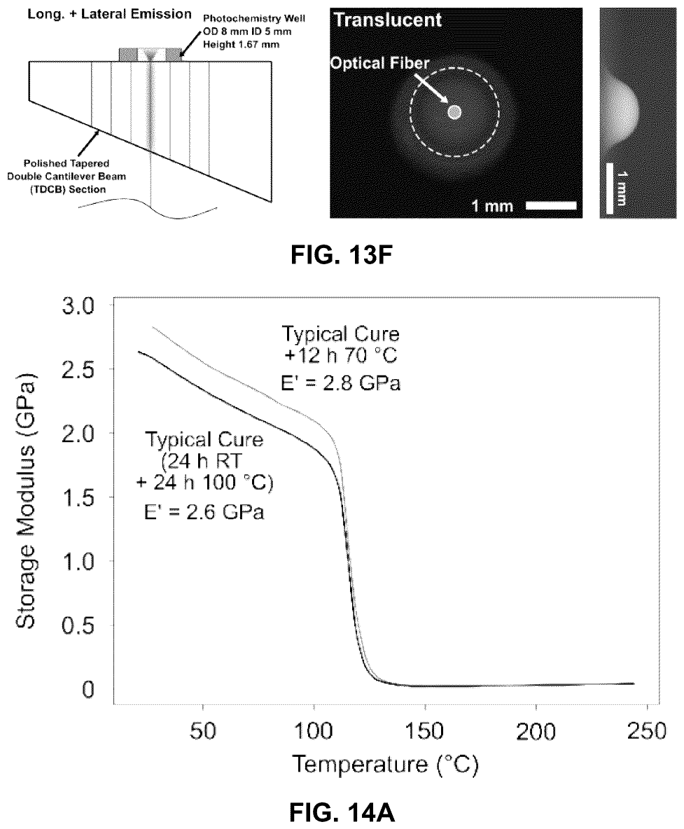

Translucent samples exhibit a primarily adhesive healed film under single fiber in situ light expo-sure that is pervades the fracture surface. By contrast, opaque samples experience discrete healed areas extending several millimeters from the fractured fiber surfaces. This discrepancy can be at-tributed to additional light exposure from light escaping the optical waveguides. Internal scattering of light within the polymer optical fibers (POFs) allows for the radial transmission of light into the surrounding epoxy matrix. FIG. 13A demonstrates how a translucent host material transmits this additional light to the fracture surface allowing for a greater exposed area. The carbon black within opaque samples effectively absorbs this material preventing transmission to the fracture surface. Optical fiber exposure experiments are conducted to observe polymerization due to dosing of an optical fiber immersed in liquid photochemistry. Schematics seen in FIG. 13B detail the experimental setup, whereby annealed optical fibers are immersed in liquid photochemistry, on glass slides, at the fiber midspan and cleaved end. Polymerization at the midspan provides evidence of photoinitiation due solely to radial emission. In contrast, the cleaved end provides a combination of side- and end-emission photoinitiation while avoid a fiber-air interface to reflect in situ test conditions more closely. Samples are exposed for 45 min using the optical setup described in FIGS. 13A-13E, and immediately imaged to avoid additional polymerization due to dark cure. As expected representative optical micrographs in FIG. 13C show the presence of cured photopolymer along the length of both pristine and etched fibers, confirming sufficient light is transmitted to initiate polymerization. Etched fibers exhibited a nearly uniform 30 μm thick layer across the fiber midspan, and a 2.5 mm diameter surrounding the cleaved end. In contrast, pristine fibers exhibit a more varied polymerized region ranging from 30 to 140 μm from the fiber cladding and more irregular region at the fiber end. Variations in polymerized regions suggest an interaction between fiber/-cladding transition modes and the etching procedure. Polymerization initiated solely by fiber-end emission is assessed by exposing optical fibers embedded within translucent and opaque TDCB specimens as seen in FIG. 13D. Virgin TDCB samples are sectioned with a low-speed wet saw and polished to a final grit of 0.04 μm ( 1/10 laser wavelength). A silicone gasket with an inside diameter of 5 mm is centered on the central optical fiber and filled with photochemistry. Rinsing of residual photochemistry reveal an elliptical volume of polymerized monomer around the exposed optical fiber. The healed volumes seen in FIG. 13D measure 0.6 mm wide and 1.7 mm tall in the translucent sample, exceeding the 0.9 mm by 0.3 mm volume seen in the opaque sample. It is likely, in both cases the initial light exposure at the fiber surface produces an initial plug of material that limits further transmission of light. For the opaque sample, this suggests that the short height is due to the radial diffusion of protonic acid from this central plug. This same behavior is repeated in the translucent sample but with additional protonic acid generation from the radially emitted light.

TDCB dC/Da Calibration

Determining mode-I fracture toughness using the crack-length independent TDCB geometry assumes a constant α that incorporates elastic modulus (E) and crack compliance (dC/da). Modifications of the TDCB geometry necessary to enable light delivery, channel protection, and fluid delivery modify the samples crack compliance. A α-calibration study is conducted to ensure accurate comparison between sample sets using the methods outlined in Brown46 to calculate a according to the following relation:

$${K}_{IC} = 2 {P}_{c} \sqrt{\frac{m}{{b}_{n} b}} = α {P}_{c}$$

where P_{c} is the peak fracture load, bn is the crack width, and b is the specimen width. The geometric constant m is defined as:

$$m = \frac{Eb}{8} \frac{dC}{da}$$

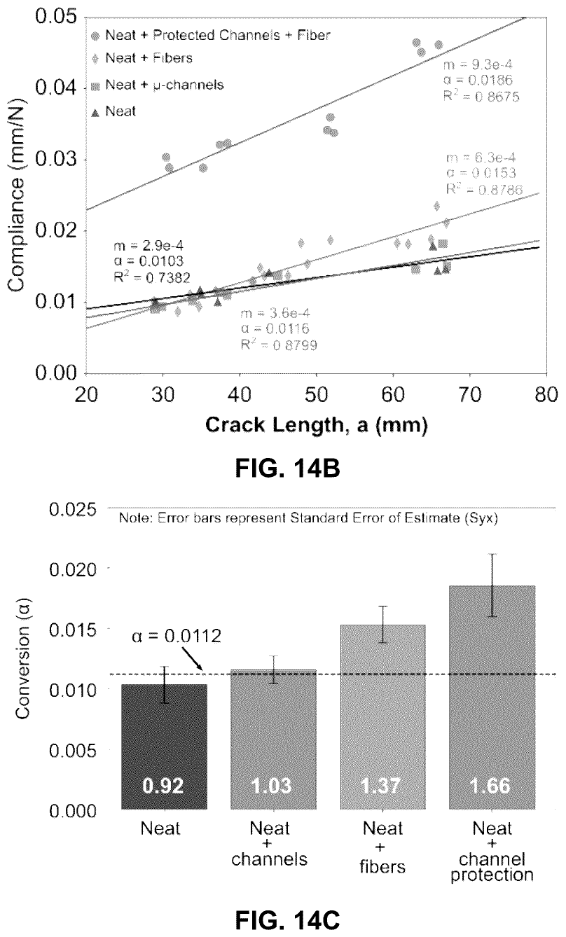

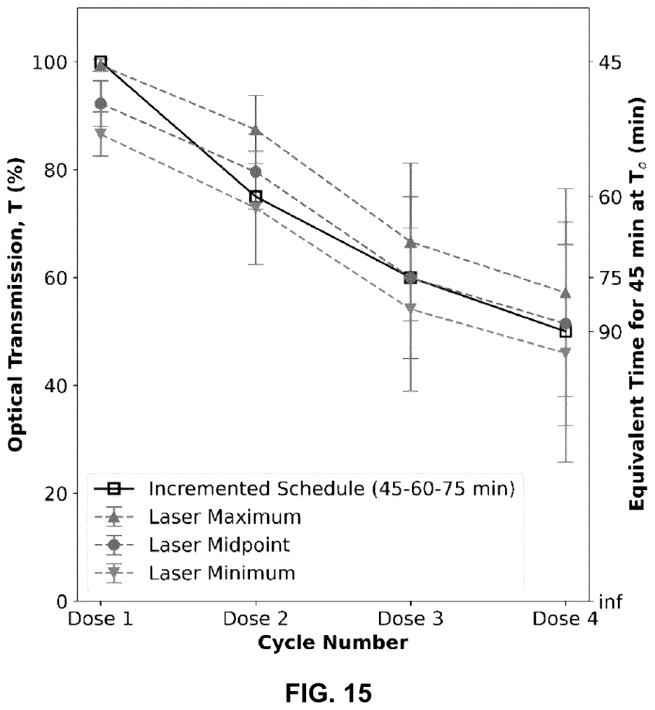

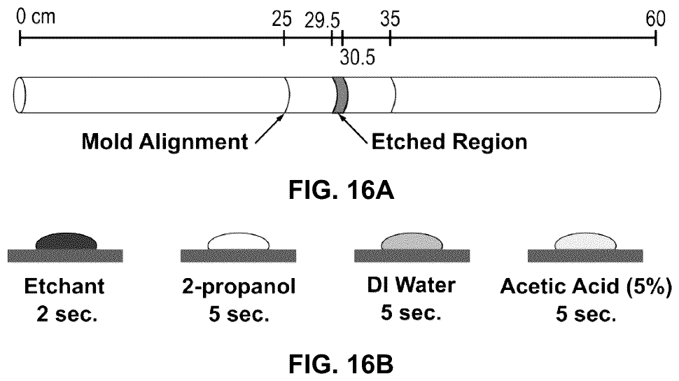

A TA Instruments Q800 dynamic mechanical analyzer measures—at room temperature—the elastic modulus of an epoxy beam (10 mm×50 mm×2 mm) for each relevant oven cycle. Images of the sample fracture plane are captured during mode-I fracture experiments concurrently with load and displacement. Crack length is measured from images continuously captured (10 Hz) during mode-I fracture toughness experiments using the image analysis program FIJI/ImageJ (NIH, ver. 1.54b). Results in FIGS. 14A-14C reveal a moderate (10%) increase in storage modulus from the additional channel cure cycle.

Crack length measurements obtained optically from images captured during mode-I fracture experiments are plotted against compliance at each successive fracture in FIG. 14B. dC/da is calculated as the slope of a line fit via linear regression. As seen herein, little change in the final a value with the addition of either embedded POF or internal micro-channels. However, a significant change is observed by the addition of carbon black protected channels likely an effect of the high particle loading (1 wt %) and additional cure cycle for channel protection.

### Incremental Healing Schedule

Automated healing experiments exhibit a gradual loss of optical transmission at the targeted healing wavelength (405 nm) over successive cycles. Operating under a constant exposure time results in a parallel drop in healing efficiency due to reduced photonic energy delivery. To ensure consistent dosing across healing cycles an incremental healing schedule is adopted where exposure time increases during each successive cycle. Ultimately, an exposure cycle with an initial 45 min exposure and each successive cycle increasing by 15 min is chosen.

### Optical Fiber Processing

Bond strength between the fiber's fluorocarbon cladding and the surrounding epoxy matrix is improved by the application of a fluoropolymer etchant (FluoroEtch, Action Technologies) according to manufacturer instructions. Optical fibers (Eska SK10, Mitsubishi Rayon Co.) are first cut to lengths of 60 cm and secured in groups of six spaced 3 mm apart. Two sets of markings are then made along each fiber (i) 25 and 35 cm to align with the TDCB mold; (ii) at 29.5 and 30.5 cm for a 10 mm etched region. Flash tape is then placed at the first set of markings to maintain spacing at the etch region. Fibers are etched by submersing in FluoroEtch for 2 seconds, then rinsing in 2-propanol for 5 seconds to deactivate the etchant and remove the central markings. Fibers are then submersed in water and then a solution of 5% acetic acid to further neutralize the alkaline etchant, each for 5 seconds. Residual moisture is gently removed with a lint-free tissue (Kimwipe, Kimberly-Clark), and fibers are allowed to air dry for 1 hour before sample fabrication.

### Specimen Manufacture

Samples were cast using two mating silicone molds (RTV 630, Momentive) placed between two aluminum plates and secured with spring clamps. A two-part epoxy (Huntsman Araldite 8605/Aradur 8605) at a resin:hardener ratio of 100:35 by weight was used. After hand mixing, the combined epoxy is degassed for 40 mins at 2 Torr (abs.) before being poured directly into the assembled molds. Oven curing occurs after samples sit for 24 h at RT, at a modified cure cycle of 24 h at 100° C.

Molds were poured at 10:1 ratio between the base material (100 g) and curing agent (10 g), as specified by the manufacturer. The silicone material was degassed for 30 minutes, then poured into a machined aluminum master mold. The viscous material was allowed to settle in the mold in open air, before being oven cured at 100° C. for 1 hour.

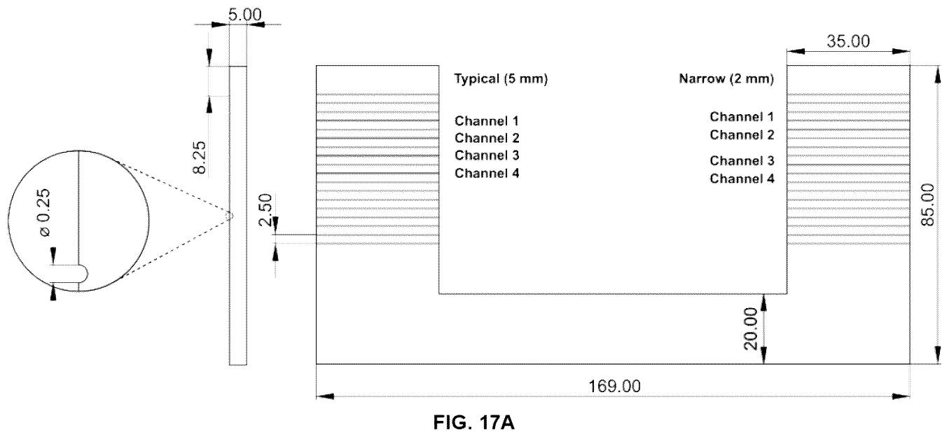

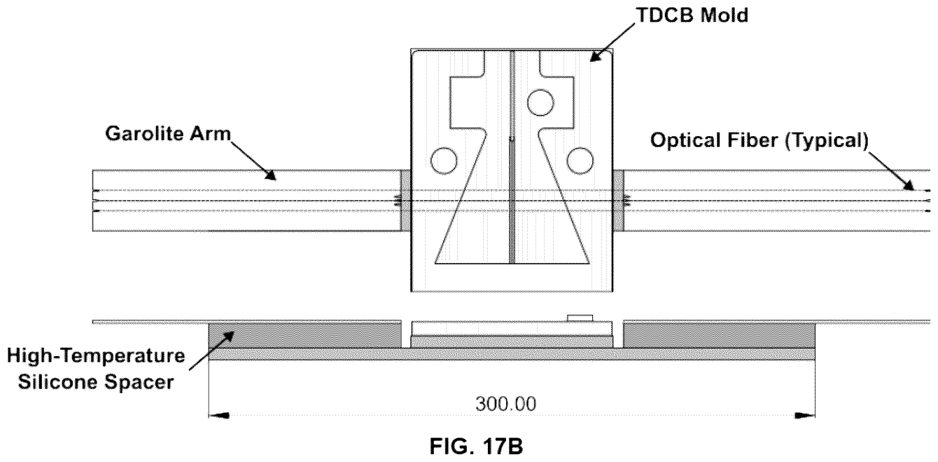

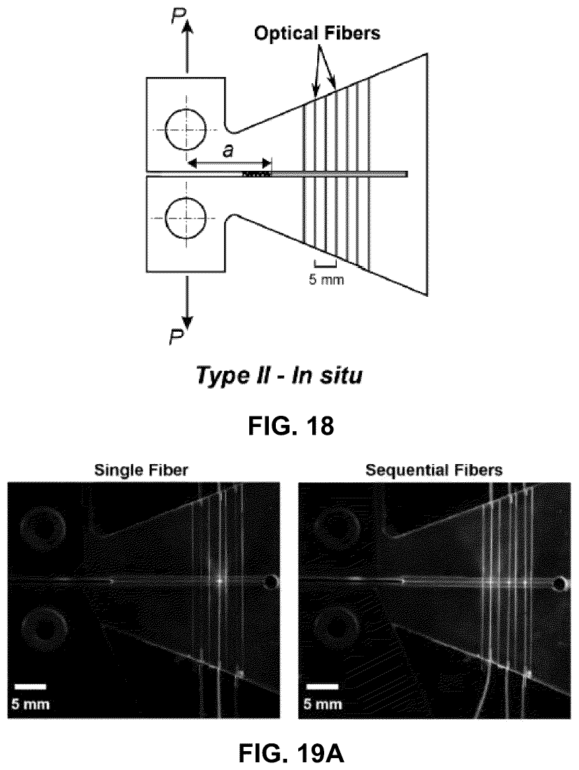

Micro-channels are formed by securing fluorocarbon monofilament (VSP6-15, Berkley) to one of the silicone mold halves. Filament alignment is achieved with the aid of an acrylic template with 18 notches at a 2.5 mm spacing (FIG. 17A). Filaments are cut to approximately 20 cm and pulled taught over the mold, tension is maintained by taping filaments to the surrounding table. Small strips of flash tape (5 mm×20 mm) adhered parallel to the TDCB taper secure the filaments to the mold before filaments are trimmed along the outside edge of the flash tape.

An additional alignment template FIG. 17B is utilized for samples containing both internal micro-channels and embedded optical fibers. Garolite arms with machined grooves are used to align optical fibers while maintaining the fiber pretension necessary to overcome thermally induced shrinkage strain. High-temperature silicone is used to separate the garolite from the supporting aluminum bar. A filament containing mold half is centered on the central aluminum plate and secured with double sided tape to prevent movement. Etched optical fibers (SI Section S11) are laid across the silicone mold with the mold edge aligning with the outermost set of marks on the fiber. PTFE sleeves (0.254 mm ID, 35 mm length) are placed on each fiber to prevent damage at the sample edge during demolding. Lead weights (25 g) are attached to one end of the fiber while the free end is secured to the opposing garolite arm. Fiber ends are clamped with c-clamps to the edge of each garolite arm. Fibers are protected from crushing by placing 25 mm square of high temperature silicone and glass-fiber composite between the fiber and clamp.

### Raman Analysis of Healed Fracture Topology

Quantitative assessment of photopolymer conversion is conducted via Raman spectroscopy scans of a healed fracture surface. Prior to scanning, baselines are obtained of the liquid photochemistry and fully converted photopolymer to establish an upper and lower bound of the oxirane/phenyl ratio, respectively. A photopolymer reference film is generated by exposing liquid chemistry at a dose of 7500 mJ/cm² and allowed to sit for 48 h to allow for maximum conversion. Adhesive and cohesive regions were excised from ex situ samples dosed at 4500 mJ/cm² and 2500 mJ/cm². Films are excised by scraping a sharp edge of epoxy across the crack plane to remove the film while avoiding damage to the underlying thermoset matrix. All materials are scanned on aluminum foil to avoid signal pollution. Scans were acquired with a confocal Raman microscope (XploRA Plus+ Syncerity OE (detector), HORIBA) with the acquisition settings detailed in Table 3. Scans are manually baselined to ensure consistent behavior across sessions and then normalized to the invariant reference peak (1610 cm⁻¹).

TABLE 3
Raman Spectroscopy Acquisition Parameters for XploRA Plus

| Parameter | Value |
|---|---|
| Range (cm⁻¹) | 200 to 2000 |
| Acquisition Time (s) | 30 |
| Accumulations | 3 |
| Filter (%) | 25 |
| Laser (nm) | 785 |
| Slit (μm) | 200 |
| Hole (μm) | 500 |
| Grating | 1200 |

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### REFERENCES

1. Aizenberg, J., et al. Biological glass fibers: Correlation between optical and structural properties. Proceedings of the National Academy of Sciences 101, 3358-3363 (2004).
2. Avilés, F., et al. Piezoresistivity, strain, and damage self-sensing of polymer composites filled with carbon nanostructures. Advanced Engineering Materials 20, 1701159 (2018).
3. Bai, H. et al. Stretchable distributed fiber-optic sensors. Science 370, 848-852 (2020).
4. Bai, H., et al. Autonomous self-healing optical sensors for damage intelligent soft-bodied systems. Science Advances 8, eabq2104 (2022).
5. Blaiszik, B. et al. Self-healing polymers and composites. Annual Review of Materials Research 40, 179-211 (2010).
6. Bleay, S., et al. A smart repair system for polymer matrix composites. Composites Part A: Applied Science and Manufacturing 32, 1767-1776 (2001).
7. Brown, E. N. Use of the tapered double-cantilever beam geometry for fracture toughness measurements and its application to the quantification of self-healing. The Journal of Strain Analysis for Engineering Design 46, 167-186 (2011).
8. Brown, E. N., et al. Fracture testing of a self-healing polymer composite. Experimental Mechanics 8 (2002).
9. Brown, E. N. et al. Composites Science and Technology, 65(15-16):2474-2480, 2005.
10. Brown, E. N., et al., Journal of Material Science 39 (2004): 1703-1710.
11. Burnworth, M, et al. Nature, 472(7343):334-337, 2011.
12. Chen, X. A thermally re-mendable cross-linked polymeric material. Science 295, 1698-1702 (2002).
13. Cohades, A., et al. Progress in self-healing fiber-reinforced polymer composites. Advanced

Materials Interfaces 5, 1800177 (2018).
14. Corten, C. C. et al. Repairing polymers using oscillating magnetic field. Advanced Materials 21, 5011-5015 (2009).
15. Crivello, James V. Journal of Polymer Science: Part A: Polymer Chemistry 37 (1999): 4241-4254.
16. Cusano, A et al. An optoelectronic sensor for cure monitoring in thermoset-based composites.

Sensors and Actuators A: Physical, 84(3):270-275, 2000.
17. Davami, K. et al. Additively manufactured self-healing structures with embedded healing agent reservoirs. Scientific Reports 9, 7474 (2019).
18. De Baere, I et al. On the nonlinear evolution of the Poisson's ratio under quasi-static loading for a carbon fabric-reinforced thermoplastic. Part I: Influence of the transverse strain sensor. Polymer Testing, 28(2):196-203, 2009.
19. Devi, U. et al. A microvascular-based multifunctional and reconfigurable metamaterial. Advanced Materials Technologies 6, 2100433 (2021).
20. Diesendruck, C. E., et al. Biomimetic self-healing. Angewandte Chemie International Edition 54, 10428-10447 (2015).
21. Ficek, B A et al. Cationic photopolymerizations of thick polymer systems: Active center lifetime and mobility. European Polymer Journal, 44(1):98-105, 2008.
22. Fiore, G L et al. Optically healable polymers. Chemical Society Reviews, 42(17):7278, 2013.
23. Fratzl, P. et al. Nature's hierarchical materials. Progress in Materials Science 52, 1263-1334 (2007).
24. Garcia, M. E., et al. Autonomous materials with controlled toughening and healing. Journal of Applied Physics 108, 093512 (2010).
25. Gergely, R C R et al. A Microvascular System for the Autonomous Regeneration of Large Scale Damage in Polymeric Coatings: Autonomous Regeneration of Polymeric Coatings. Advanced Engineering Materials, 19(11):1700319, 2017.
26. Gergely, R C R et al. Regenerative Polymeric Coatings Enabled by Pressure Responsive Surface Valves: Regenerative Coatings: Surface Valves. Advanced Engineering Materials, 19(11):1700308, 2017.
27. Ghosh, B. et al a. Science, 323(5920):1458-1460, 2009.
28. Grattan K et al. Fiber optic sensor technology: an overview. Sensors and Actuators A: Physical, 82(1-3):40-61, 2000.
29. Greene, W. A. Industrial Photoinitiators: A Technical Guide (CRC Press, Boca Raton, 2010).
30. Gurtner, G. C., et al. Wound repair and regeneration. Nature 453, 314-321 (2008).
31. Guyton, A. et al. Textbook of Medical Physiology (Saunders Elsevir, Philadelphia, 2005).
32. Habault, D et al. Chemical Society Reviews, 42(17):7244, 2013.
33. Hamilton, A. R. et al. Advanced Materials, 22(45):5159-5163, 2010.
34. Hamilton, A R et al. Local Strain Concentrations in a Microvascular Network. Experimental Mechanics, 50(2):255-263, 2010.
35. Hamilton, A. R., et al. Pressurized vascular systems for self-healing materials. Journal of The Royal Society Interface 9, 1020-1028 (2012).
36. Hansen, C J et al. Accelerated Self-Healing Via Ternary Interpenetrating Microvascular Networks. Advanced Functional Materials, 21(22):4320-4326, 2011.
37. Hansen, C. J. et al. Self-Healing Materials Advanced Materials, 21(41):4143-4147, 2009.
38. Hart, K. R. et al. Repeated healing of delamination damage in vascular composites by pressurized delivery of reactive agents. Composites Science and Technology 151, 1-9 (2017).
39. Hartwig, A et al. Influence of moisture on the photochemically induced polymerisation of epoxy groups in different chemical environment. Polymer, 8, 2002.
40. Huang, C Y et al, Journal of The Royal Society Interface, 7(49):1229-1241, 2010.
41. John Wiley & Sons, Encyclopedia of Polymer Science and Technology (Wiley, 2002), 1 edn.
42. Kewitsch A S et al. Self-focusing and self-trapping of optical beams upon photopolymerization. Optics Letters, 21(1):24, 1996.
43. Kim, J. K. et al. Composite Science and Technology 60 (2000): 745-761.
44. Lee, B. Review of the present status of optical fiber sensors. Optical Fiber Technology, 9(2):57-79, 2003.
45. Lu, P. et al. Distributed optical fiber sensing: Review and perspective. Applied Physics Reviews 6, 041302 (2019).
46. Lyon, R E et al. In situ cure monitoring of epoxy resins using fiber-optic Raman spectroscopy. Journal of Applied Polymer Science, 53(13):1805-1812, 1994.
47. Meure, S., et al. Polyethylene-co-methacrylic acid healing agents for mendable epoxy resins. Acta Materialia 57, 4312-4320 (2009).
48. Mitsubishi Chemical Corporation, EskaTMSK10. Tech. Rep., Tokyo, Japan (2019).
49. Montarnal, D., et al. Silica-like malleable materials from permanent organic networks. Science 334, 965-968 (2011).
50. Norris, C. J. et al. Autonomous stimulus triggered self-healing in smart structural composites. Smart Materials and Structures 21, 094027 (2012).
51. Odarczenko, M. et al. Sunlight-activated self-healing polymer coatings. Advanced Engineering Materials 22, 1901223 (2020).
52. Patrick, J. F. et al. Continuous self-healing life cycle in vascularized structural composites. Adv. Mater. 8 (2014).
53. Patrick, J. F., et al. Polymers with autonomous life-cycle control. Nature 540, 363-370 (2016).
54. Peters, K. Polymer optical fiber sensors-a review. Smart Materials and Structures 20, 013002 (2011).
55. Qamar, I. P. S., et al. Grand challenges in the design and manufacture of vascular self-healing. Multifunctional Materials 3, 013001 (2020).
56. Reece, J. B. et al. Campbell's Biology, vol. 12 (Pearson, Boston, 2020).
57. Reupert, A., et al. Radiation from side-emitting optical fibers and fiber fabrics: Radiometric model and experimental validation. Advanced Photonics Research 3, 2100104 (2022).
58. Rifaie-Graham, O., et al. Self-reporting fiber-reinforced composites that mimic the ability of biological materials to sense and report damage. Advanced Materials 30, 1705483 (2018).
59. Sakurayama, N., et al. Sensing and healing of disbond in composite stiffened panel using hierarchical system. Composite Structures 132, 833-841 (2015).
60. Schissel, S. M. et al. Controlling shadow cure in cationic photopolymerizations using physical cues and processing variables. Journal of Applied Polymer Science 137, 48290 (2020).
61. Schütt, H. et al. Capillary crack imbibition: A theoretical and experimental study using a hele-shaw cell: Pure and Applied Geophysics 158, 627-646 (2001).
62. Sipani, V. et al. Dark-cure studies of cationic photopolymerizations of epoxides: Characterization of the active center lifetime and kinetic rate constants. Journal of Polymer Science Part A: Polymer Chemistry 41, 2064-2072 (2003).
63. Sipani, V et al. Dark cure studies of cationic photopolymerizations of epoxides: Characterization of kinetic rate constants at high conversions. Journal of Polymer Science Part A: Polymer Chemistry, 42(17):4409-4416, 2004.
64. Snyder, A. D. et al. Prolonged in situ self-healing in structural composites via thermo-reversible entanglement. Nature Communications 13, 6511 (2022).
65. Song, Y. J. et al. A self-repairing polymer waveguide sensor. Smart Materials and Structures 20, 065005 (2011).
66. Stajanca, P. et al. Molecular alignment relaxation in polymer optical fibers for sensing applications. Optical Fiber Technology, 28:11-17, 2016.
67. Tee, B. C. K., et al. An electrically and mechanically self-healing composite with pressure- and flexion-sensitive properties for electronic skin applications. Nature Nanotechnology 7, 825-832 (2012).
68. Toohey, K. S., et al. Delivery of two-part self-healing chemistry via microvascular networks. Advanced Functional Materials 19, 1399-1405 (2009).
69. Toohey, K S et al. Self-healing materials with microvascular networks. Nature Materials, 6(8):581-585, 2007.
70. Trask, R. S. et al. Biomimetic self-healing of advanced composite structures using hollow glass fibres. Smart Materials and Structures 15, 704-710 (2006).
71. Wang, S. et al. Self-healing polymers. Nature Reviews Materials 5, 562-583 (2020).
72. White, K. L, et al. Polymer 53 (2012): 37-42.
73. White, S. R. et al. Autonomic healing of polymer composites. Nature 409, 794-797 (2001).
74. White, S. R. et al. Restoration of large damage volumes in polymers. Science 344, 620-623 (2014).
75. Yang, Q et al. Light-Switchable Self-Healing Hydrogel Based on Host-Guest Macro-Crosslinking. Macromolecular Rapid Communications, 38(6):1600741, 2017.
76. Yilmaz, C et al. Monitoring Poisson's ratio of glass fiber reinforced composites as damage index using biaxial Fiber Bragg Grating sensors. Polymer Testing, 10, 2016.
77. Zhou G et al. Damage detection and assessment in fibre-reinforced composite structures with embedded fibre optic sensors-review. Smart Materials and Structures, 11(6):925-939, 2002.
78. Zhu, Y., et al. Synthesis of UV-responsive self-healing microcapsules and their potential application in aerospace coatings. ACS Applied Materials & Interfaces 11, 33314-33322 (2019).
79. Ziemann, 0, editor. POF handbook: optical short range transmission systems. Springer, Berlin, 2nd ed edition, 2008.

What is claimed is:

1. A self-healing system comprising:
(a) a structural polymer;
(b) a plurality of optical fibers or polymer waveguides embedded in the structural polymer; and
(c) a plurality of micro-channels through the structural polymer,
wherein the micro-channels are configured to deliver a curing composition comprising a photo-polymerizable liquid monomer to at least one site of damage in the system.

2. The self-healing system of claim 1, wherein the structural polymer comprises a thermoset polymer, a thermoplastic polymer, or a polymer-matrix composite.

3. The self-healing system of claim 2, wherein the thermoset polymer comprises an epoxy, a polyurethane, a polyamide, or any combination thereof.

4. The self-healing system of claim 2, wherein the thermoplastic polymer comprises poly(methyl methacrylate) (PMMA), polyethylene (PE), polypropylene (PP), polyether ether ketone (PEEK), or any combination thereof.

5. The self-healing system of claim 1, wherein the optical fibers comprise polymer optical fibers, and wherein the polymer optical fibers comprise a core and a cladding.

6. The self-healing system of claim 1, wherein the polymer waveguides achieve light transmission without a dedicated cladding.

7. The self-healing system of claim 1, wherein the plurality of micro-channels form an interconnected network, wherein one or more of the plurality of micro-channels comprises an isolated channel, or both.

8. The self-healing system of claim 1, wherein the photo-polymerizable liquid monomer comprises diglycidyl ether of bispehnol A (DGEBA) and reactive viscosity reducer 1,4-butanediol diglycidyl ether.

9. The self-healing system of claim 1, wherein the curing composition further comprises a sensitizer, wherein the sensitizer comprises anthracene or an anthracene derivative; a toughening agent, wherein the toughening agent comprises a phase-separated star block copolymer; or both.

10. The self-healing system of claim 1, wherein the curing composition further comprises a photo-initiator, a free-radical initiator, or any combination thereof.

11. The self-healing system of claim 1, wherein the self-healing system is translucent or opaque.

12. The self-healing system of claim 1, wherein the damage comprises Mode-I fracture.

13. The self-healing system of claim 1, wherein the damage fractures at least one of the plurality of micro-channels and, optionally, at least one of the plurality of optical fibers or optical waveguides, at least a portion of the structural polymer, or both.

14. The self-healing system of claim 13, wherein fracture of the at least one of the plurality of micro-channels releases the curing composition around a site of the damage.

15. A method for in situ self-healing of at least one site of damage in the system of claim 1, the method comprising irradiating the at least one site of damage using UV or visible light from one or more of the plurality of optical fibers or optical waveguides.

16. The method of claim 15, wherein irradiating is carried out at from about 400 to about 410 nm and wherein irradiating delivers a dose of energy of from about 0.75 to about 5400 mJ/cm² to the at least one site of damage.

17. The method of claim 15, further comprising detecting the at least one site of damage prior to irradiating.

18. The method of claim 17, wherein detecting the at least one site of damage is accomplished by identifying an intensity drop in through-transmission of visible light in at least one of the plurality of optical fibers or polymer waveguides.

19. The method of claim 15, wherein the self-healing system experiences at least 65% structural recovery after performing the method.

20. The method of claim 15, wherein the self-healing system experiences recovery of intensity of through-transmission of visible light in at least one of the plurality of optical fibers or polymer waveguides after performing the method.
